(19) United States
(12) Patent Application Publication
(10) Pub. No.: US 2024/0236961 A1
(43) Pub. Date: Jul. 11, 2024

(54) LOW COMPLEXITY, LOW POWER, LOW LATENCY SYNCHRONIZATION AND BEAM MANAGEMENT SESSION FOR SUB-THZ LINK ACTIVATION

(71) Applicant: QUALCOMM Incorporated, San Diego, CA (US)

(72) Inventors: Daniel PAZ, Geva Carmel (IL); Michael LEVITSKY, Rehovot (IL)

(21) Appl. No.: 18/151,365

(22) Filed: Jan. 6, 2023

(51) Int. Cl. H04W 72/0453; H04W 56/00

(52) U.S. Cl. CPC H04W 72/0453; H04W 56/00

(57) ABSTRACT

An apparatus configured to receive, from a first network node via a first frequency band, a first indication of a set of configuration parameters for a synchronization session for a second frequency band; receive, from a second network node via the second frequency band and based on the first indication, a set of reference signals associated with the synchronization session; and transmit, to the first network node via the first frequency band, a second indication of at least one of a synchronization state or a beam management report associated with the synchronization session for the second frequency band.

### TECHNICAL FIELD

The present disclosure relates generally to communication systems, and more particularly, to synchronization and beam management (BM) operations associated with a high-frequency (e.g., subTHz) link.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to receive, from a first network node via a first frequency band, a first indication of a set of configuration parameters for a synchronization session for a second frequency band. The apparatus may also be configured to receive, from a second network node via the second frequency band and based on the first indication, a set of reference signals associated with the synchronization session. The apparatus may further be configured to transmit, to the first network node via the first frequency band, a second indication of at least one of a synchronization state or a beam management report associated with the synchronization session for the second frequency band.

In an aspect of the disclosure, a method, a computer-readable medium, and an apparatus are provided. The apparatus may be configured to transmit, for a second network node via a first frequency band, a first indication of a first set of configuration parameters for transmitting a first set of reference signals associated with a synchronization session for a second frequency band. The apparatus may also be configured to transmit, for a wireless device via the first frequency band, a second indication of a second set of configuration parameters for receiving the first set of reference signals associated with the synchronization session for the second frequency band. The apparatus may further be configured to receive, from the wireless device via the first frequency band, a third indication of at least one of a synchronization state or a beam management report associated with the synchronization session for the second frequency band.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a subTHz wireless communication network.

FIG. 5 is a diagram illustrating aspects of the synchronization and BM session associated with a subTHz timing synchronization between a first device (or a first node) and a second device (or a second node) associated with a particular hop (or link) in a single-hop, or multi-hop, subTHz link in accordance with some aspects of the disclosure.

FIG. 6 is a diagram illustrating a set of beams for a synchronization and BM session associated with BM or BR for one of a first hop for a multi-hop subTHz link and/or a direct subTHz link in accordance with some aspects of the disclosure.

FIG. 7 is a diagram illustrating a set of beams for a synchronization and BM session associated with BM or BR for one of an intermediate and/or last hop for a multi-hop subTHz link in accordance with some aspects of the disclosure.

FIG. 8 is a call low diagram illustrating operations associated with a set of synchronization and BM sessions for a multi-hop SCell/subTHz link in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an apparatus.

FIG. 14 is a diagram illustrating an example of a hardware implementation for a network entity.

FIG. 15 is a diagram illustrating an example of a hardware implementation for a network entity.

### DETAILED DESCRIPTION

In some aspects of wireless communication, subTHz frequency communication bursts (e.g., short term communication for performing fast data transmission) may be associated with an initial acquisition procedure that is performed for each “burst.” A multi-dimensional search performed for each initial acquisition, may lead to high power, high complexity, high latency synchronization and BM procedures. Accordingly, a low complexity, low power, low latency synchronization and BM session for subTHz/SCell single or multi-hop link activation for each “burst” is presented in the disclosure. The synchronization and BM session may reduce the scope of a multi-dimensional search for initial acquisition to achieve the reduced complexity, power, and latency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

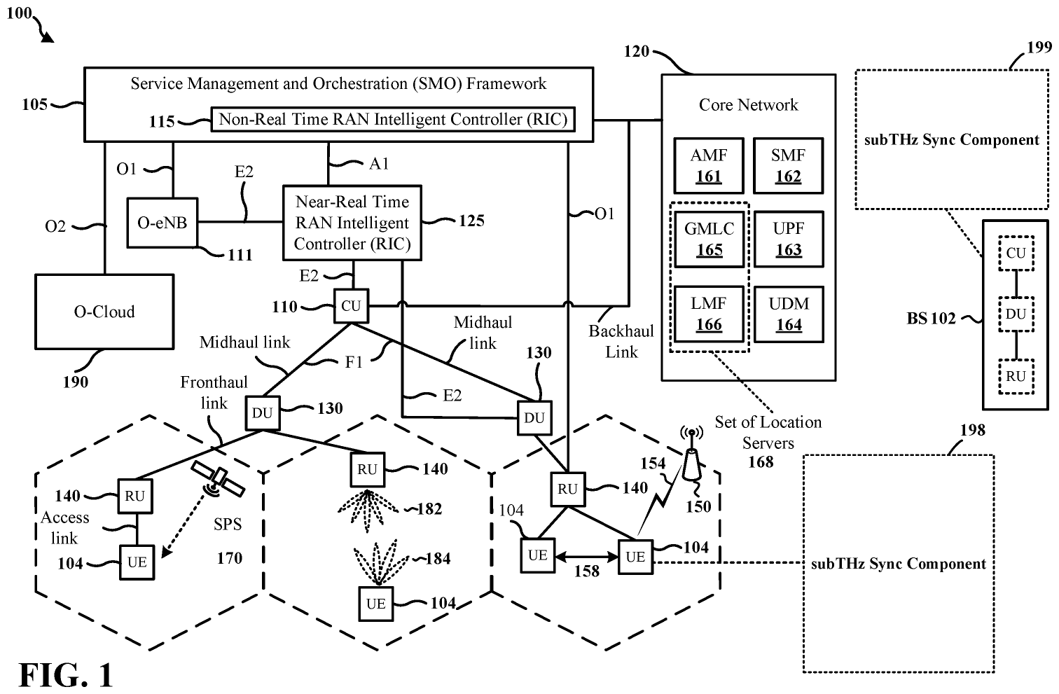

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a subTHz sync component 198 that may be configured to receive, from a first network node via a first frequency band, a first indication of a set of configuration parameters for a synchronization session for a second frequency band. The subTHz sync component 198 may also be configured to receive, from a second network node via the second frequency band and based on the first indication, a set of reference signals associated with the synchronization session. The subTHz sync component 198 may further be configured to transmit, to the first network node via the first frequency band, a second indication of at least one of a synchronization state or a beam management report associated with the synchronization session for the second frequency band. In certain aspects, the base station 102 may have a subTHz sync component 199 that may be configured to transmit, for a second network node via a first frequency band, a first indication of a first set of configuration parameters for transmitting a first set of reference signals associated with a synchronization session for a second frequency band. The subTHz sync component 199 may also be configured to transmit, for a wireless device via the first frequency band, a second indication of a second set of configuration parameters for receiving the first set of reference signals associated with the synchronization session for the second frequency band. The subTHz sync component 199 may further be configured to receive, from the wireless device via the first frequency band, a third indication of at least one of a synchronization state or a beam management report associated with the synchronization session for the second frequency band. The disclosure relates generally to improving initial acquisition procedures for high-frequency communication.

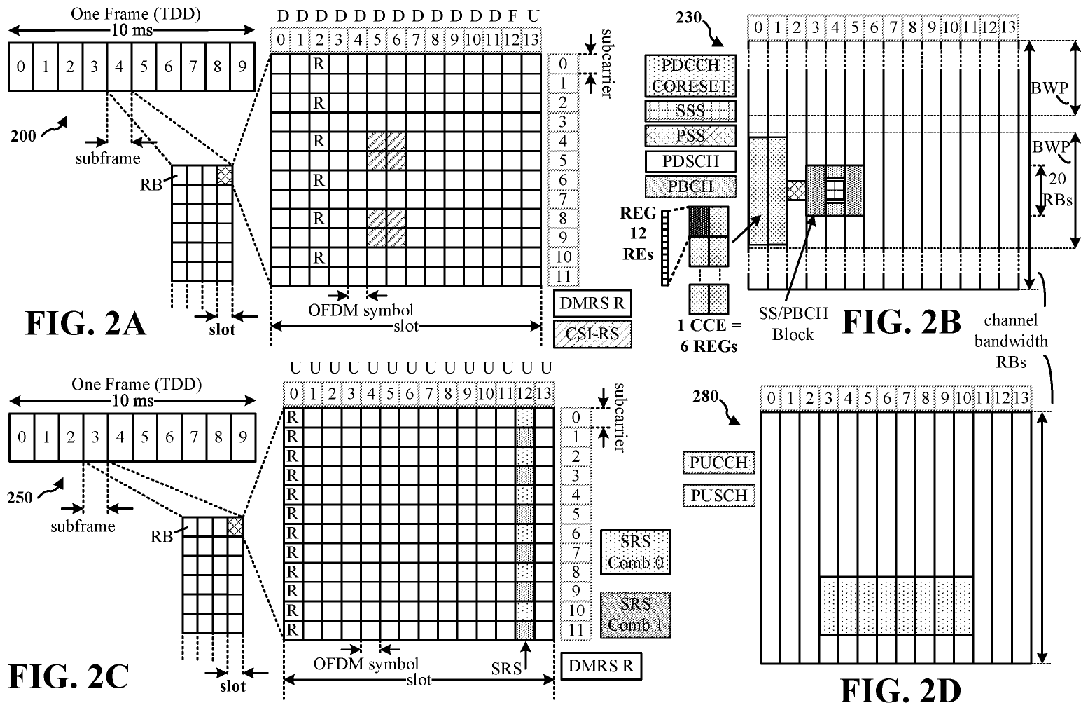

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology p=4 has a subcarrier spacing of 240 kHz. The symbol length/duration is inversely related to the subcarrier spacing. FIGS. 2A-2D provide an example of normal CP with 14 symbols per slot and numerology p=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

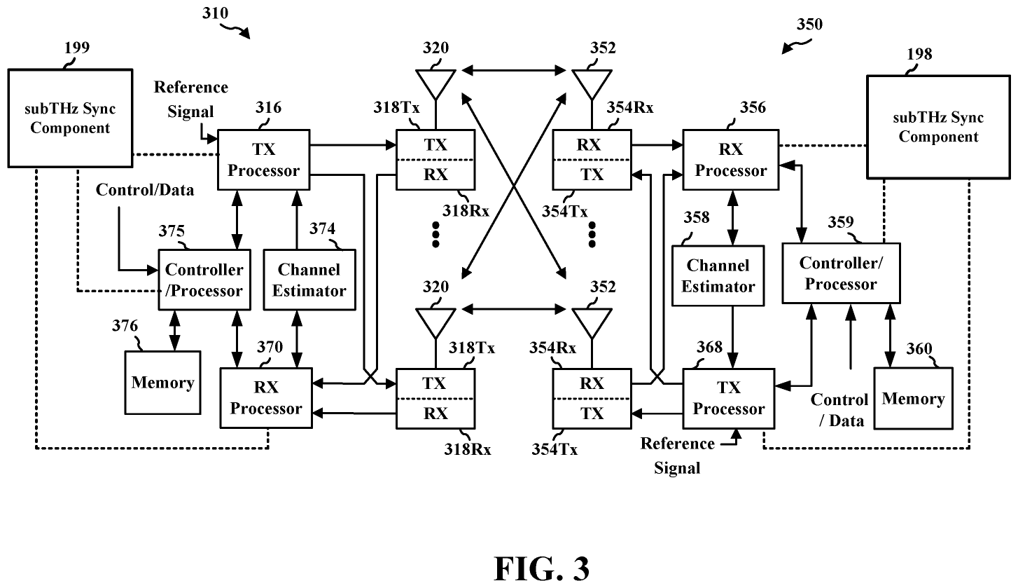

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the subTHz sync component 198 of FIG. 1.

At least one of the TX processor 316, the RX processor 370, and the controller/processor 375 may be configured to perform aspects in connection with the subTHz sync component 199 of FIG. 1.

A wireless communication system may allow for transmission and reception of data over a subTHz frequency band. The term “subTHz frequency band” may refer to FR4 and/or FR5. The subTHz frequency band may allow for faster data rates in comparison to other frequency bands (e.g., FR1, FR2, FR4). However, a wireless communication system that utilizes subTHz frequencies may have limited coverage compared to a wireless communication system that utilizes other frequency bands. For instance, a subTHz wireless communication system may have limited maximum power amplifier (PA) output power characteristics compared to a mm-wave wireless communication system. For instance, the subTHz wireless communication system may have 10 dB less maximum PA output power than a mm-wave wireless communication system. Furthermore, a subTHz wireless communication system may utilize a higher signal bandwidth in comparison to a mm-wave wireless communication system which may result in an equivalent isotropically radiated power (EIRP) deficit for a subTHz which limits coverage of the subTHz wireless communication system. In an example, a subTHz wireless communication system may have two to three times less range than a mm-wave wireless communication system. A subTHz wireless communication system may have a reduction in PA efficiency by at least of factor of two (compared to a mm-wave wireless communication system) which may result in lower subTHz link power/energy efficiency. In an example, subTHz PA efficiency may range from 1-8% depending on a power backoff (BO). In an example, a PA may transmit at a power level. Input power to the PA may vary. A power BO may be configured with respect to the power level such that output of the PA is not saturated. Furthermore, to provide a fast target data rate, a subTHz wireless communication system may utilize a SCS that is eight times higher than a SCS for a mm-wave wireless communication system due to a higher signal bandwidth associated with subTHz wireless communications. In comparison to a mm-wave wireless communication system, a subTHz wireless communication system may have less efficient RF processing, a higher power consumption related to analog to digital (A2D) and digital to analog (D2A) components having higher sampling rates (i.e., roughly linearly translated to consumed power), higher rate digital processing rates, higher bit rates addressed on a decoder side, and higher memory and storage related power consumption.

As a result of the aforementioned issues, a subTHz wireless communication system (i.e., a subTHz deployment) may be configured as follows. First, as noted above, subTHz may have limited coverage compared to other wireless communication systems. To address this issue, a subTHz wireless communication system may achieve broader coverage using other frequency bands (FR1/FR2/FR4) in addition to a subTHz frequency band. For instance, a subTHz wireless communication may be deployed in a non-standalone (NSA)/self-contained deployment. A subTHz deployment may target UEs that have relatively large data traffic specifications. Second, as noted above, a subTHz deployment may be less efficient from a power efficiency perspective compared to other wireless communication systems. To address this issue, a subTHz deployment may utilize lower frequency bands (e.g., FR1/FR2/FR4) for relatively small data transmissions and control related signaling and link maintenance procedures. This may be referred to as “traffic offloading.” Traffic offloading may be achieved via access points (APs) configured for subTHz communications that are placed in locations that have a relatively high data volume demand potential. Third, due to power/battery specifications and relatively high data volumes target for subTHz links, a number of simultaneously active subTHz UEs in an area may be limited. To address this issue, an AP may provide a per demand high-capacity channel to subTHz-eligible UEs that may be registered under a lower band/PCell. The per demand high-capacity channel may be referred to as a side band or as a supplementary high-capacity channel that has a burst activity pattern for sparse usage in time. subTHz eligible UEs may be continuously subscribed/connected to a lower band/PCell.

As noted above, a UE within a subTHz deployment may be continuously connected to a PCell. A subTHz link may be dynamically activated for a time period in which a subTHz eligible UE may receive/transmit relatively large amounts of data to/from a base station in order to increase power efficiency. If a SCell/subTHz link is activated for a UE, the UE (and/or intermediate devices such as repeating units or APs) may obtain, determine, and/or transmit information relating to one or more of synchronization and/or beam management (BM) for the SCell/subTHz link. In some aspects, the information relating to the synchronization and/or BM for the SCell/subTHz link may include a configuration of a set of RSs used to perform synchronization and/or BM procedures and/or operations. SCell/subTHz synchronization and BM may be based on synchronization/BM characteristics of the PCell. For instance, there may be a “warm start” for each subTHz link activation based on the known synchronization/BM characteristics of the PCell. The configuration of the set of RSs used to perform synchronization and/or BM procedures for SCell/subTHz link activations may be associated with relatively fast, low complexity, low power, and/or low latency synchronization and BM procedures.

Various technologies pertaining to synchronization and BM for a SCell/subTHz link are described herein. In an example, a receiving wireless device (e.g., a UE, AP, or repeating point) may receive an indication of a set of configuration parameters for a synchronization and/or BM session associated with the SCell and/or subTHz. The set of configuration parameters, in some aspects, may indicate a timing, frequency, and/or directionality (e.g., beam direction or quasi co-location) of a set of SSBs (e.g., SSB mini bursts). The receiving wireless device may, in some aspects, receive the set of SSBs based on the set of configuration parameters from a transmitting device (e.g., a base station, another AP, or another repeating point). The receiving wireless device, in some aspects, may transmit one or more of a synchronization state indication or a BM report. The synchronization state, in some aspects, may indicate whether the receiving device successfully detected the synchronization RS (e.g., successfully received the RS and determined a local timing offset for the SCell/subTHz link from a timing offset associated with the PCell). The BM report, in some aspects, may include a list of best Tx beam indexes (beam IDs) from a list of beam indexes (e.g., beam indexes included in the set of configuration parameters) associated with the synchronization and/or BM session associated with the SCell and/or subTHz. In some aspects, the beam IDs may also be associated with corresponding reference signal received power (RSRP) and/or reference signal strength indicator (RSSI) measurements for each beam. The SCell/subTHz link activation and associated synchronization and/or BM procedures may be repeated serially for additional subTHz links and/or devices (“hops” using subTHz communication) in a series of devices between a source device and a destination device. In some aspects, one or more hops may use wired communication for one or more of Rx or Tx.

In some aspects, the various aspects described below may lead to reduced complexity of an initial acquisition based on the synchronization and BM procedures for a SCell compared to a standard initial acquisition based on “always on” connections. The synchronization and BM procedures, in some aspects, may provide network power consumption reduction and may reduce activation latency for a multi-hop subTHz link. The synchronization and BM procedures, in some aspects, may avoid UE association ambiguity (e.g., when smart repeaters are involved in subTHz link establishment) and/or SSB scalability issues. Additionally, in some aspects, the synchronization and BM procedures (e.g., associated with a synchronization and BM session) may allow a generic support for multi hop links without restricting a number of intermediate devices, e.g., APs and/or smart repeaters, allowing an extended range and/or mesh topology.

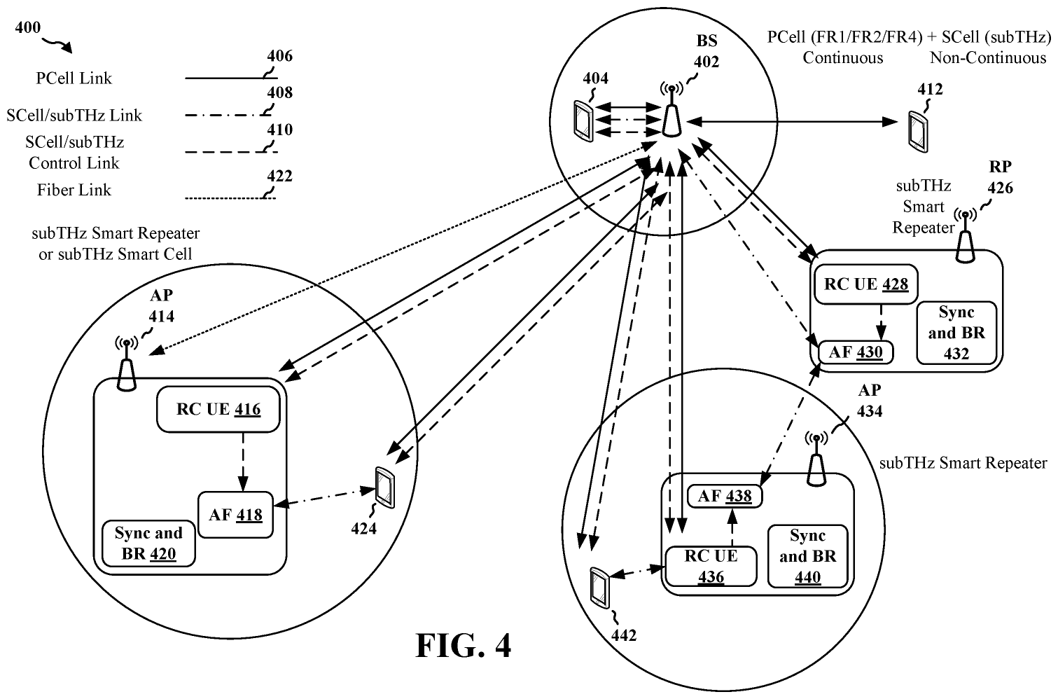

FIG. 4 is a diagram 400 illustrating an example of a subTHz wireless communication network. The subTHz wireless communication network may include a base station 402. The base station 402 may be configured to operate in a first frequency band (e.g., FR1/FR2/FR4) and a second frequency band (e.g., subTHz), where the second frequency band is greater than the first frequency band. Stated differently, the base station 402 may transmit and receive signals/data to/from UEs and/or repeaters via FR1/FR2/FR4 and/or subTHz frequency bands. In an example, the base station 402 may be associated with an inter band carrier aggregation (CA) configuration. In such a configuration, FR1/FR2/FR4 may be referred to as a “PCell” and the subTHz frequency band may be referred to as an “SCell.” The subTHz wireless communication network may be based on spot-based coverage with a range of the PCell. The SCell/subTHz may rely upon the PCell for control and/or scheduling. UEs may have a continuous connection to the PCell while having a non-continuous connection to the SCell/subTHz. For instance, the base station 402 may activate the SCell/subTHz for sporadic and typically short time sessions. Such sessions may be associated with a burst activity pattern. SCell/subTHz synchronization and BM may be based on synchronization/BM characteristics of the PCell. For instance, there may be a “warm start” for each subTHz link activation. SCell/subTHz activations may be associated with relatively fast, low complexity, low power, and/or low latency synchronization and BM procedures.

The subTHz wireless communication network may include a UE 404. The UE 404 may include a first radio that is capable of transmitting/receiving data/signals via/with/over FR1/FR2/FR4 and a second radio that is capable of transmitting/receiving data/signals via/with/over a subTHz frequency band. Alternatively, the UE 404 may include a radio that is capable of transmitting/receiving data/signals via/with/over FR1/FR2/FR4 and the subTHz frequency band. The UE 404 may communicate with the base station 402 via/with/over a PCell link 406, where the PCell link 406 is associated with at least one of FR1/FR2/FR4. For subTHz data transmission/reception purposes, the UE 404 may also communicate with the base station 402 via/with/over a SCell/subTHz link 408. The SCell/subTHz link 408 may be associated with a subTHz frequency band. For subTHz control signaling purposes, the UE 404 may communicate with the base station 402 via/with/over a SCell/subTHz control link 410. The subTHz wireless communication network may also include a UE 412 that may communicate with the base station 402 via/with/over the PCell link 406. The UE 412 may not be configured with a radio that is capable of transmitting/receiving data/signals at the subTHz frequency band. Alternatively, the UE 412 may not meet criteria (described in greater detail below) for subTHz communication with the base station 402.

As noted above, communications at the subTHz frequency band may be range limited. subTHz range limitations may be bridged via one or more repeaters (single or multiple hop), that is, the one or more repeaters may facilitate single or multiple hops between a subTHz UE (e.g., UE 424 or UE 442) and a subTHz transceiver of the base station 402. A repeater may enable a line of sight channel (LOS) between the base station 402 and UEs. A repeater may enable subTHz communications to penetrate and/or bypass obstacles that impede a LOS channel. Furthermore, a repeater may extend an effective range of the base station 402. A repeater may receive a wireless signal from a base station and amplify and/or redirect the wireless signal. In an example, the repeater may transmit different beams in different directions at different points in time based upon the wireless signal. A UE may receive the wireless signal via one of the (redirected) different beams.

In an example, the subTHz wireless communication network may include an access point (AP) 414. The AP 414 may be referred to as a repeater, a smart repeater, or a subTHz smart repeater. The AP 414 may be associated with a subTHz smart cell. The AP 414 may be relatively power efficient and may utilize out-of-band (OOB) control signaling based on the PCell. The AP 414 may include a reduced capacity (redcap or RC) UE 416 for PCell connectivity. The RC UE 416 may deliver OOB control/reporting/feedback. The AP 414 may include wideband (WB) amplification and forwarding (AF) functionality (referred to in the diagram 400 as “AF 418”) for subTHz data forwarding. The AP 414 may also include dedicated NB reference signal (RS) transmission (Tx)/reception (Rx) functionality (referred to in the diagram 400 as “sync and BR 420”) over the subTHz frequency band for complementary time synchronization and/or beam refinement (i.e., interband (IB) processing). The AP 414 may provide for progressive synchronization across hops between repeaters, hop specific synchronizations, and/or BM sessions with customized synchronization RS/SSB mini burst scheduling.

The AP 414 may communicate with the base station 402 via/with/over a fiber link 422. The AP 414 (e.g., through the RC UE 416) may communicate with the base station 402 via/with/over the PCell link 406 and the SCell/subTHz control link 410. The RC UE 416 may communicate with the AF 418 via/with/over the SCell/subTHz control link 410.

The subTHz wireless communication network may include a UE 424. The AP 414 and the UE 424 may have a direct connection (i.e., a service link). The UE 424 may communicate with the base station 402 via/with/over the PCell link 406 and the SCell/subTHz control link 410. The AF 418 and the UE 424 may communicate via/with/over the SCell/subTHz link 408.

The subTHz wireless communication network may include a repeater (RP) 426. The RP 426 may be referred to as a repeater, a smart repeater, or a subTHz smart repeater. The RP 426 may be relatively power efficient and may utilize OOB control signaling based on the PCell. The RP 426 may be configured with similar functionality as the AP 414. The RP 426 may have different hardware and/or capabilities than the AP 414. The RP 426 may have an intermediate or a direct link (i.e., a donor link) with the base station 402. The RP 426 may include a RC UE 428 for PCell connectivity. The RC UE 428 may be similar or identical to the RC UE 416 described above. The RP 426 may include AF 430 for subTHz data forwarding. The AF 430 may be similar to the AF 418 described above. The RP 426 may also include sync and BR 432 over the subTHz frequency band for complementary time synchronization and/or beam refinement. The sync and BR 432 may be similar or identical to the sync and BR 420 described above. The RP 426 may provide for progressive synchronization across hops between repeaters, hop specific synchronizations, and/or BM sessions with customized synchronization RS/SSB mini burst scheduling.

The RP 426 (e.g., through the RC UE 428) may communicate with the base station 402 via/with/over the PCell link 406 and the SCell/subTHz control link 410. The RC UE 428 may communicate with the AF 430 via/with/over the SCell/subTHz control link 410. The AF 430 may communicate with the base station 402 via/with/over the SCell/subTHz link 408.

The subTHz wireless communication network may include an AP 434. The AP 434 may be referred to as a repeater, a smart repeater, or a subTHz smart repeater. The AP 434 may be relatively power efficient and may utilize OOB control signaling based on the PCell. The AP 434 may be configured with similar functionality as the AP 414 and/or the RP 426. The AP 434 may have different hardware and/or capabilities than the AP 414 and/or the RP 426. The AP 434 may have a direct connection to UEs (i.e., a service link). The AP 434 may include a RC UE 428 for PCell connectivity. The RC UE 436 may be similar to the RC UE 416 described above. The AP 434 may include AF 438 for subTHz data forwarding. The AF 438 may be similar to the AF 418 described above. The AP 434 may also include sync and BR 440 over the subTHz frequency band for complementary time synchronization and/or beam refinement. The sync and BR 440 may be similar or identical to the sync and BR 420 described above. The AP 434 may provide for progressive synchronization across hops between repeaters, hop specific synchronizations, and/or BM sessions with customized synchronization RS/SSB mini burst scheduling.

The AP 434 (e.g., via the AF 438) may communicate with the AF 430 of the RP 426 via/with/over the SCell/subTHz link 408. The AP 434 (e.g., via the RC UE 436) may communicate with the base station 402 via/with/over the PCell link 406 and the SCell/subTHz control link 410. The RC UE 436 and the AF 438 may communicate via the SCell/subTHz control link 410.

The subTHz wireless communication network may include a UE 442. The AP 434 and the UE 442 may have a direct connection (i.e., a service link). The UE 442 may communicate with the base station 402 via/with/over the PCell link 406 and the SCell/subTHz control link 410. The UE 442 and the RC UE 436 may communicate via/with/over the SCell/subTHz link 408.

In one aspect, a UE (e.g., the UE 404, the UE 412, the UE 424, the UE 442) may be configured by the base station 402 with eligibility criteria for transmitting/receiving subTHz communications. If the eligibility criteria are met, the UE may transmit/receive data over a subTHz band. If the eligibility criteria are not met, the UE may transmit/receive data over a frequency band other than the subTHz band (e.g., FR1/FR2/FR4). The eligibility criteria may include the UE being located within a subTHz coverage range of the base station 402, the AP 414, the RP 426, and/or the AP 434. The eligibility criteria may include a mobility condition (e.g., a speed) of the UE being less than a threshold (i.e., semi-static subTHz beam and channel). In an example, a channel may be set to static or semi-static (i.e., the semi-static channel may change slowly over time). A serving beam may be used for relatively long durations if the channel is static or semi-static. The eligibility criteria may include the UE being capable of subTHz communications (e.g., the UE is equipped with a radio that is capable of transmitting and receiving subTHz communications). The eligibility criteria may include battery resources (e.g., a remaining battery charge) of the UE meeting a threshold. The eligibility criteria may include a volume (i.e., amount) of data that is to be transmitted or received by the UE exceeding a threshold volume (i.e., amount).

In one aspect, a UE may perform SCell/subTHz DL synchronization with a base station based on a PCell synchronization procedure. The UE may not utilize a local frequency tracking loop or frequency synchronization for the SCell/subTHz. Instead, frequency tracking (and corresponding parts per million error (referred to herein as “ppm_err”)) based on PCell connectivity may be reused/projected onto a subTHz frequency band for UL and/or DL transmissions. Coarse timing and/or a coarse beam for a receiving UE and/or for each hop (or node) in a multi-hop subTHz link associated with a receiving UE, in some aspects, may be derived based on PCell timing and beam information (e.g., information regarding a start of a PCell slot and/or symbol or information regarding a coarse beam associated with a PCell transmission). The PCell timing and/or beam information may be available at the hop, node, and/or UE based on an established PCell link, e.g., based on a RACH or initial acquisition process associated with the PCell.

For example, a direct link between the UE and a base station providing the SCell/subTHz link (e.g., including and/or providing the PCell and SCell) may, in some aspects, use PCell connectivity information, e.g., information related to beams, channels, precoding, and/or tracking associated with the PCell connectivity and/or link to determine the coarse timing and/or beam information. In some aspects, the coarse timing and/or beam information may be based on location information and/or PCell based positioning and ray tracing for UE to AP links. The coarse timing and/or beam information, in some aspects, may be based on a one time beam sweep as a part of a smart repeater installation and/or power on (or boot up) procedure for one or more fixed links between smart repeaters and base station (gNB) and/or fixed LOS infrastructure links (other smart repeaters and/or fixed APs).

The above coarse timing and/or beam information and other aspects of the disclosure may allow for a reduced complexity, power, and latency subTHz synchronization and beam acquisition for each hop (node) for each link activation as will be discussed below. The concepts discussed below may apply to direct (e.g., network device to UE) and indirect (network device to UE via a multi-hop network including one or more smart repeaters, RPs, and/or APs) links over subTHz. A generic synchronization and beam acquisition process described below may be applied by each hop or node for a subTHz link establishment and activation. In some aspects, a multi-hop link synchronization procedure may be based on a progressive synchronization approach. SCell/subTHz DL timing synchronization may be established for each component (e.g., UEs, RPs, APs) in a subTHz link (e.g., a multi hop subTHz link). The SCell/subTHz DL timing synchronization may be a progressive synchronization. For example, a first operation for a SCell/subTHz link synchronization may include synchronizing a first node (e.g., a repeater or AP) in a DL direction to a base station (e.g., gNB or other network device) based on a set of custom SCell/subTHz RS. Subsequent nodes (including a destination and/or final UE), in some aspects, may be serially synchronized to an immediately-previous node in order from the first node towards the UE (or destination device) based on a local subTHz DL synchronization of the immediately-previous node.

SCell/subTHz DL timing synchronization, in some aspects, may refer to a process in which a UE (or an AP or an RP) detects a radio boundary (i.e., a time at which a radio frame starts) and an OFDM symbol boundary (i.e., a time at which an OFDM symbol starts). Furthermore, prior to performing SCell/subTHz UL synchronization, each component in the subTHz link may be continuously connected to a PCell. As such, a PCell timing (a timing associated with the slots and/or symbols of the PCell link) may be known (and a propagation delay may be estimated) for each component.

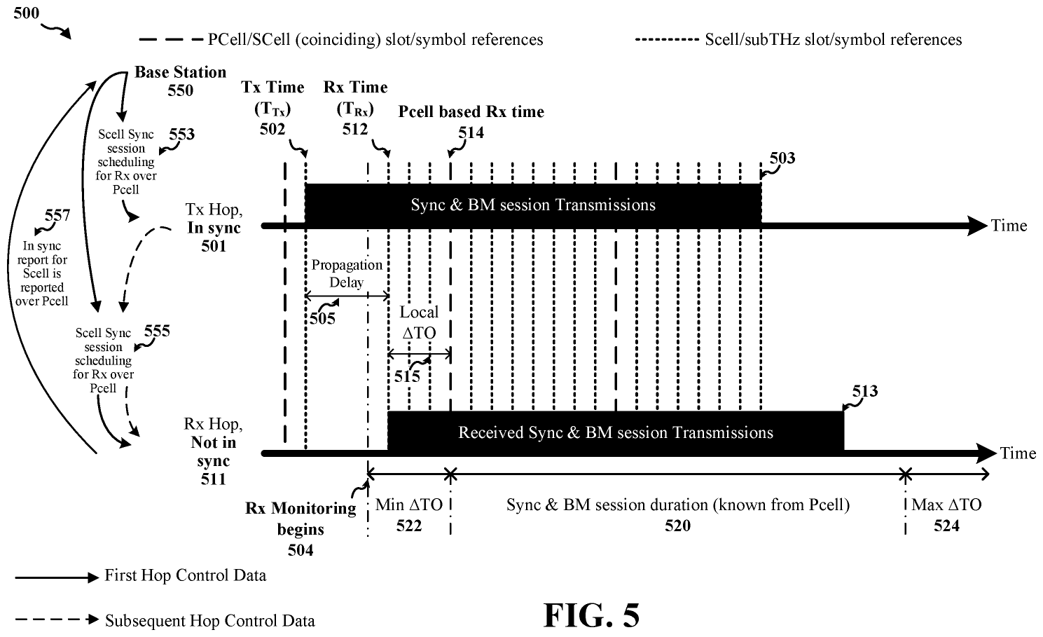

As discussed above, a synchronization and BM procedure (or session) may be performed for (or associated with) each activation of a subTHz link and may be configured to achieve a time synchronization and serving Tx/Rx beam refinement/determination for the subTHz link. FIG. 5 is a diagram 500 illustrating aspects of the synchronization and BM session associated with a subTHz timing synchronization between a first device 501 (or a first node) and a second device 511 (or a second node) associated with a particular hop (or link) in a single-hop, or multi-hop, subTHz link in accordance with some aspects of the disclosure. The timing synchronization illustrated in diagram 500 may be for a subTHz link associated with (or related to) a PCell link using a different frequency band (e.g., FR1/FR2/FR4). The PCell link (as an example of OOB communication in regards to the subTHz link) may be used, in some aspects, to transmit and/or receive control information (e.g., configuration parameters or reports) for the subTHz synchronization and BM session. For example, for a first hop between a first and/or source node of a multi-hop subTHz link (e.g., first device 501) and a next node (or hop) (e.g., second device 511) a PCell link between the first device 501 and the second device 511 may be used to transmit and/or receive configuration parameters (e.g., sync session scheduling 555) for the synchronization (and BM) session transmissions 503. For an intermediate (or last) hop, a PCell link between a base station 550 (e.g., a first and/or source node in a multi-hop subTHz link) and the first device 501 may be used to communicate configuration parameters (e.g., sync session scheduling 553) for the synchronization (and BM) session transmissions 503. Similarly, a PCell link between a base station 550 and the second device 511 may be used to communicate configuration parameters (e.g., sync session scheduling 555) for the received synchronization (and BM) session transmissions 513. For example, in some aspects, the synchronization and BM session scheduling may be done over PCell and by referring to PCell timing (e.g., a PCell slot/symbol index as a coarse time reference for a reduced scope for an initial acquisition on the activated/established subTHz link). As described above, the synchronization and BM session may be scheduled by a gNB (as an example of a network node or base station) over a PCell link for both the Tx and Rx nodes for a particular hop.

In some aspects, the PCell link between the base station 550 and the first device 501 may be associated with a first frequency band (e.g., one of FR1, FR2, or FR4) while the PCell link between the base station 550 and the second device 511 may be associated with a second frequency band (e.g., one of FR1, FR2, or FR4). The first and second frequency bands, in some aspects, may be the same frequency band or different frequency bands. Additionally, or alternatively, the PCell link between the base station 550 and the first device 501 and the PCell link between the base station 550 and the second device 511 may be independently configured such that they are associated with different link characteristics (e.g., a frequency range, numerology, modulation and coding scheme (MCS), Tx and/or Rx beams, etc.). Similarly, the SCell/subTHz link between different devices or nodes for a multi-hop subTHz link may be associated with different link characteristics (e.g., a frequency range within the subTHz frequency band, numerology, modulation and coding scheme (MCS), Tx and/or Rx beams, etc.).

The configuration parameters (e.g., sync session scheduling 553 or 555), in some aspects, may indicate a time associated with a beginning (e.g., a first reference signal in a set of reference signals) of the synchronization and BM session transmissions 503 from the first device 501. The time associated with (or the timing of) the beginning of the synchronization and BM session transmissions 503 may be indicated in relation to a first reference time using a first unit of time associated with communication via the first frequency band (e.g., a slot or symbol associated with the PCell link). For a first device 501 that is an intermediate hop, the configuration parameters may further include a second value associated with a second unit of time associated with communication via the second frequency band (e.g., a slot or symbol associated with the SCell/subTHz link). The second unit of time, in some aspects, is assumed to be smaller than the first unit of time.

In some aspects, the first unit of time and the second unit of time may be based on a numerology or SCS (e.g., proportional to 1/SCS) associated with the PCell link and the SCell/subTHz link, respectively. The numerology and/or SCS associated with a link (e.g., the PCell link and the SCell/subTHz link) may be indicated in an indication of a modulation and coding scheme (MCS) for the link. As illustrated in diagram 500, the PCell slot/symbol references (e.g., reference times based on the beginning of a PCell slot or PCell symbol) may be associated, in some aspects, with a spacing that is eight times larger than the SCell/subTHz slot/symbol references (e.g., reference times based on the beginning of a SCell/subTHz slot or SCell/subTHz symbol). The relative spacing of PCell and SCell/subTHz spacing, in some aspects, may be based on a relative SCS such that a ratio of SCSs is inversely related to a ratio of timing reference spacing (e.g., a ratio of slot lengths or symbol lengths). For example, for a PCell SCS of 15 kHz and a SCell SCS of 240 kHz, a ratio of PCell SCS to SCell SCS of 1:16 (e.g., 15 kHz:240 kHz) may be associated with a ratio of slot/symbol lengths for the PCell and the SCell of 16:1 (e.g., 1 ms: 0.0625 ms).

The following description of aspects of diagram 500, in some aspects, may be applicable for a synchronization and BM session for a direct (or single hop) subTHz link or for each hop (or individual link between nodes) for a multi-hop subTHz link as a part of a progressive timing sync procedure. For a progressive sync approach, the Tx side (e.g., first device 501) of the addressed hop may be assumed to be in sync with a previous hop (and ultimately to a first and/or source node such as base station 550). For example, addressing the first hop in DL direction, a smart repeater (or other first device 501, such as an AP or relay) connected directly to a subTHz base station 550 (e.g., a multi-TRP gNB associated with both the PCell and SCell) will be first synchronized in association with a local subTHz DL timing to the subTHz base station 550 transceiver (or TRP), where collocated PCell/subTHz base station transceivers are assumed. The Tx node (e.g., first device 501) local subTHz DL timing, in some aspects, may be given as a local subTHz delta timing offset at the Tx node added to a PCell timing at the Tx node, e.g., which may be represented as: Tx node local subTHz DL timing=local_subTHz_ΔTO@Tx_node+PCell timing@Tx_node.

Once the Tx node (e.g., first device 501) is “in sync” for subTHz DL timing, the scheduling information for the Tx node may be provided by referring to PCell DL timeline. The reference to the PCell timing may further include a translation to subTHz timeline based on the PCell timing, the local (to the Tx node) subTHz ΔTO, and a slot offset (with reference to one of PCell or subTHz slots). For example, scheduling information may correspond to a slot or symbol of the PCell at the Tx node with the addition of the delta for the local subTHz timing offset at the Tx node and an offset of a number of subTHz PCell slots, which may be expressed as: PCell slot/symbol@Tx_node+local_subTHz_ΔTO@Tx_node+# of subTHz/PCell slots offset. The scheduling information as described above, in some aspects, may be used to define the Tx time 502. Based on the local timing (e.g., PCell timing and local subTHz ΔTO), the Tx node may transmit synchronization and BM session transmissions 503 at a Tx time 502. The synchronization and BM session transmissions 503 may then be received at the Rx node after a propagation delay 505 at a Rx time 512 that is associated with a local subTHz ΔTO 515.

In some aspects, the subTHz Tx timing aligned to a local subTHz DL timing at the transmitting node (e.g., the first device 501) may enable synchronization of a local DL timing in context of the multi hop link for the next subTHz node (e.g., second device 511). The Rx side of the addressed hop (e.g., the second device 511) upon receiving the sync session scheduling 555 may not be in sync yet, but may have received a coarse timing from the PCell in the sync session scheduling 555 (e.g., a value identified by PCell slot/symbol@Rx_node+# of subTHz/PCell slots offset). The sync session scheduling 555 may indicate a PCell-slot-based, or PCell-symbol-based, Rx time 514. A subTHz and PCell timeline difference (e.g., a local subTHz ΔTO between subTHz and PCell timing) for the Rx node (second device 511), in some aspects, may be estimated and included in sync session scheduling 555. The estimated value included in the sync session scheduling 555, in some aspects, may be one or more worst case subTHz ΔTOs (e.g., an upper and/or lower bound for the subTHz ΔTO) that may be used to define a time search range for the received synchronization and BM session transmissions 513 on the Rx side of the hop. In some aspects, the lower and upper bounds may be of a same, or different magnitudes based on a known set of parameters associated with the Tx node (e.g., the first device 501) and the Rx node (e.g., the second device 511). The known set of parameters in some aspects, may include, for example, a known location of the Tx and Rx nodes and/or a distance between the Tx and Rx nodes, a known delay (e.g., a PCell ΔTO) of communication via the PCell, or other characteristics of the Tx and Rx devices. Accordingly, based on the timing indicated in the sync session scheduling 555 and the estimated local subTHz ΔTO, the Rx node (e.g., the second device 511) may schedule a monitoring window beginning at a time 504 (a time that precedes an indicated timing of the received synchronization and BM session transmissions 513 based on the PCell timing by a time based on the lower bound for the subTHz ΔTO 522). The monitoring window may then extend for a time spanning the lower bound for the subTHz ΔTO 522, a synchronization and BM session duration 520 and an upper bound for the subTHz ΔTO 524.

This worst case subTHz ΔTO, in some aspects, may be related to different propagation delays on a PCell (e.g., a direct link between the specific hop Rx side and PCell base station according to the assumed inter band CA as a basis for subTHz deployment) and on the SCell/subTHz (multi hop link between a subTHz base station and the specific hop Rx node). For example, a worst case subTHz ΔTO may depend on the distance between the specific hop Rx node and the base station and characteristics of the PCell and/or SCell bands. In some aspects, PCell links are established for every node directly with the base station and the addressed subTHz link goes over a multi-hop link trajectory so propagation characteristics may be very different in different scenarios. Since the location information of every subTHz link component (UE, RP, AP, or base station) may be known at a source base station according to the suggested subTHz deployment approach, a max and/or min subTHz ΔTO 524 and/or 522 may be configured by a base station (e.g., base station 550) over the PCell link to the Rx side node (e.g. the second device 511) of the specific synchronization and BM session (e.g., associated with synchronization and BM session transmissions 503).

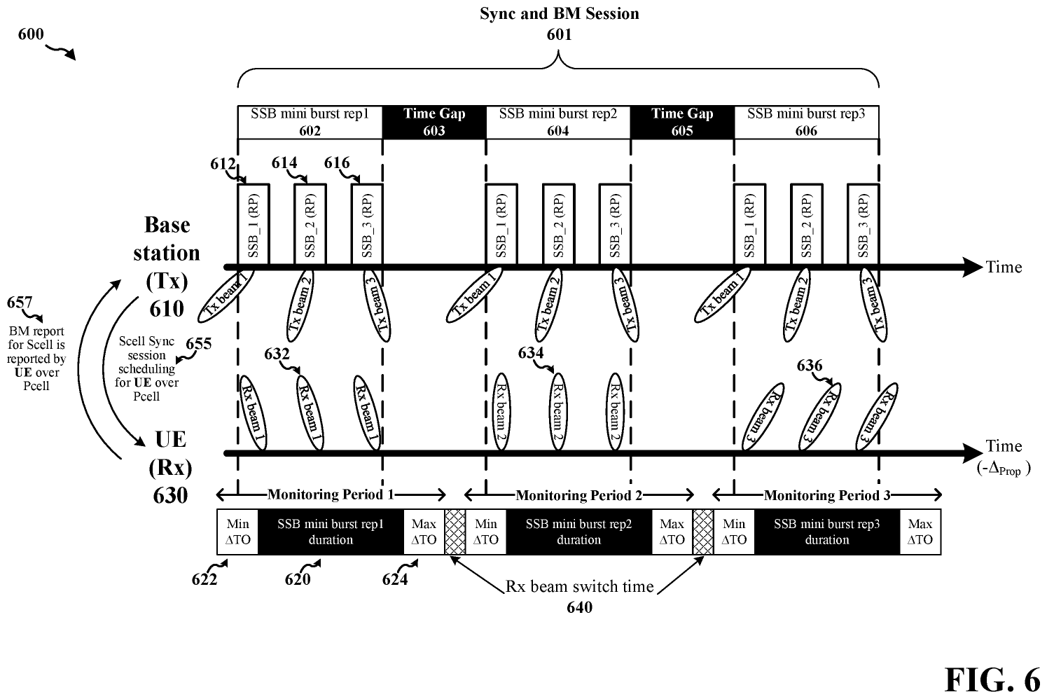

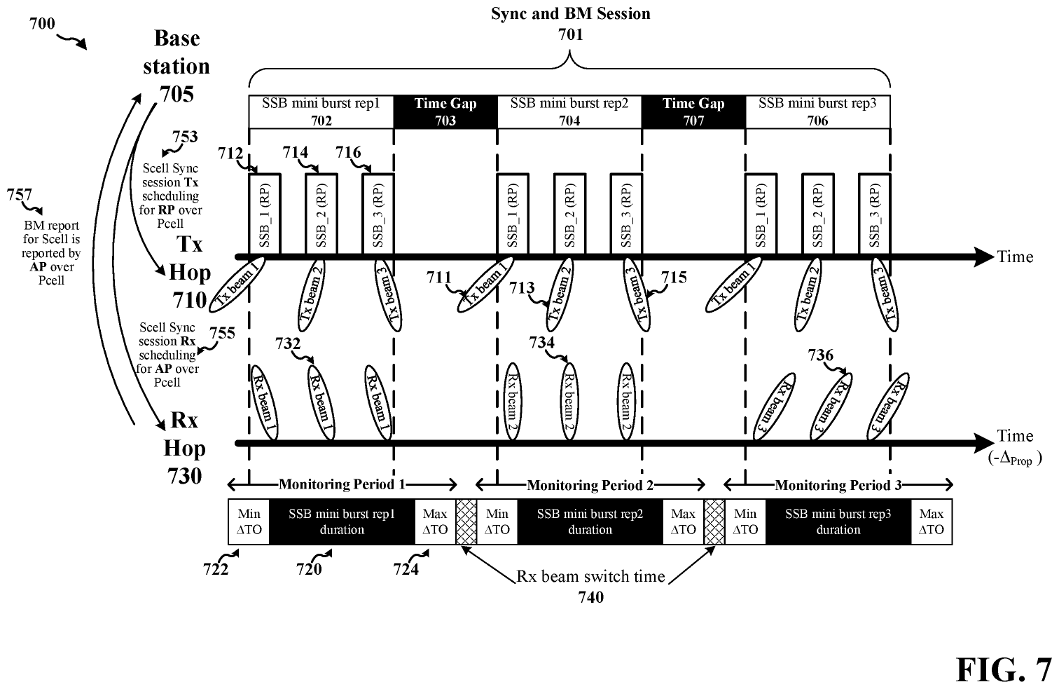

The limited time domain search based on the PCell timing and the worst case subTHz ΔTOs (where the limited time domain search may be viewed as a reduced scope initial acquisition) at the Rx node, in some aspects, may result in a detection of the synchronization and BM session transmissions 503 (or received synchronization and BM session transmissions 513). Based on the received synchronization and BM session transmissions 513, the Rx node may determine a local subTHz ΔTO 515. In some aspects, the detected transmission may be related to one of a set of swept Tx beams as described in relation to FIGS. 6 and 7. A subTHz ΔTO (e.g., the local subTHz ΔTO 515) for the Rx node (e.g., the second device 511) may be determined as a difference between an actual detection peak location in time for a specific Tx beam and its reference coarse timing expected based on the scheduling information. For example, the following calculation may be made for a local subTHz ΔTO 515: subTHz_ΔTO@Rx_node=detection_time@Tx_beam_index−Tx_beam_index*beam_duration_in_time−(PCell slot/symbol@Rx_node+# of subTHz/PCell slots offset). Once the Rx side node is synchronized based on the local subTHz DL time, a corresponding/subsequent synchronization and BM session may be scheduled for the next hop based on the same operations (e.g., corresponding calculations and transmissions).

The process and/or the operations described above in relation to FIG. 5, in some aspects, provide for synchronization and BM RS detection with a reduced time search scope (less time hypotheses to be addressed) compared to other initial acquisition processes. In some aspects, the above procedures and/or operations may also reduce the search scope in the frequency domain based on a known frequency (e.g., from a PCell frequency synchronization) such that no frequency hypotheses search is performed.

According to some aspects of the progressive synchronization approach described above, a synchronization and BM session may take place per hop (and may be hop specific) and may be allocated progressively across multi hop links in DL direction. The per hop synchronization and BM session may be based on a customized per hop synchronization and BM RS (e.g., as will be discussed in relation to FIGS. 6 and 7 below) scheduled by gNB for transmission from the corresponding hop Tx edge (in DL direction) and reception by the corresponding Rx edge of the addressed hop. For example, in some aspects, a synchronization and BM session may be scheduled this way progressively on each hop. In some aspects, a synchronization and BM session may be initiated per SCell/SubTHz link activation, where mostly short subTHz based data offloading sessions are assumed. A synchronization and BM session, in some aspects, may be initiated per threshold time period duration (or on a periodic and/or quasi-periodic basis for a relatively long-lasting active session) or based on event driven criteria (related to link failure) during an active data offloading session.

After a synchronization and BM session (per hop), the receiving node of the hop may acquire a complete subTHz timing synchronization with respect to the Tx node of the hop. In some aspects, the receiving node of the targeted by synchronization and BM session may respond with a synchronization (and BM) report 557 and/or a synchronization session feedback transmitted over the PCell link. The synchronization and BM report and/or the synchronization session feedback may include an “in sync” indication/flag. The “in sync” indication may be set to “1” if synchronization and BM RS detection procedure was successful (e.g., if the expected/configured sequence was detected with a reference signal strength indication (RSSI) and/or a reference signal received power (RSRP) greater than a threshold within the expected time uncertainty range on one of the swept Tx beam and Rx beam pairs). If there was no successful detection, then the “in sync” indication may be set to zero and the synchronization (and BM) session for this hop will be repeated with some modified session parameters (e.g., swept Tx beams range, modified Rx beams list, increased time uncertainty range configuration, increased Tx power, different RBs for NB synchronization and BM RS transmissions).

FIG. 6 is a diagram 600 illustrating a set of beams for a synchronization and BM session 601 associated with BM or BR for one of a first hop for a multi-hop subTHz link and/or a direct subTHz link in accordance with some aspects of the disclosure. FIG. 7 is a diagram 700 illustrating a set of beams for a synchronization and BM session 701 associated with BM or BR for one of an intermediate and/or last hop for a multi-hop subTHz link in accordance with some aspects of the disclosure. As the structure and content of the synchronization and BM transmissions illustrated in diagram 600 and 700 are similar, they will be discussed together in the following discussion. In some aspects, a per hop synchronization and BM session 601 and/or 701 as illustrated in FIGS. 6 and 7 may be scheduled by a base station (e.g., a base station 610 or base station 705). The base station, in some aspects, may be a network node that is a first and/or source node for a direct SCell/subTHz link such as base station 610 or a first and/or source node for a multi-hop SCell/subTHz link such as base station 705.

The per hop synchronization and BM session 601 and/or 701 may include a customized set of per-hop synchronization and BM RS. For example, synchronization and BM sessions across hops may be based on local RP/AP/UE-specific SSB mini burst (or some other synchronization and BM RS waveform) transmissions fully controlled and scheduled per hop by a first node (e.g., base station 610 or 705). The customized set of per-hop synchronization and BM RS, in some aspects, includes a reduced set of Tx beams (e.g., transmissions associated with a set of precoders or beam directions) and Rx beams (e.g., reception configurations associated with a set of precoders or beam directions). The Tx beams may be configured by the base station with one of a sequence ID, parameters, and/or a PCI defining the used sequence for the scheduled hop specific synchronization and BM session over the PCell link such that there the Rx node can avoid a sequence hypotheses search. Different subTHz links or simultaneously activated subTHz link hops under the same PCell coverage area may be configured with a different sequence IDs/PCIs to avoid mutual interference. Additionally, in some aspects, SSB raster parameters (SSB allocation in FD hypotheses) and/or SSB numerology may also be preconfigured over PCell. The configurations (e.g., a subTHz coarse beam determination), in some aspects, may be determined on the base station side based on UE, AP, RP, and/or smart repeater BM capabilities and associated accuracy/spatial uncertainty characteristics indicated over a PCell link before subTHz/SCell link activation.

The set of customized set of per-hop synchronization and BM RS for a per hop synchronization and BM session 601 and/or 701 (e.g., configured, at least in part, by sync session scheduling 655, sync session scheduling 753, or sync session scheduling 755), in some aspects, may include Tx RS 612 and/or Tx RS 712 (SSB_1), Tx RS 614 and/or Tx RS 714 (SSB_2), or Tx RS 616 and/or Tx RS 716 (SSB_3) associated with Tx beam 611 and/or Tx beam 711 (Tx beam 1), Tx beam 613 and/or Tx beam 713 (Tx beam 2), and Tx beam 613 and/or Tx beam 715 (Tx beam 3), respectively, on the Tx side. The set of customized set of per-hop synchronization and BM RS for a per hop synchronization and BM session 601 and/or 701 may include, for example, Rx beam 632 or Rx beam 732 (Rx beam 1), Rx beam 634 or Rx beam 734 (Rx beam 2), and Rx beam 636 or Rx beam 736 (Rx beam 3) on the Rx side. In some aspects, the Tx beams 711-715 may be swept inside an angular sector/span around a known coarse Tx beam direction (e.g., based on a PCell beam direction) and may be tested with several Rx beam hypotheses around a known coarse Rx beam direction (e.g., based on a Rx beam direction associated with the PCell link).

The Tx RS (e.g., Tx RS 612-616 or 712-716 corresponding to Tx beams 611-615 or 711-715, respectively) may be configured and/or scheduled for transmission by a Tx node of the current (addressed) hop (e.g., base station 610 or Tx hop 710). The Rx beams (e.g., Rx beams 632-636 or 732-736) may be configured for reception of the Tx RS associated with the Tx beams at the Rx node of a current (addressed) hop (e.g. UE 630 or Rx hop 730) such that each Tx beam is received via each of the Rx beams as illustrated in diagrams 600 and 700. While the Tx and Rx hops of diagrams 600 and 700 use a similar set of Tx RS and Tx and Rx beams, each hop may be configured with different Ts RS, e.g., different coding or content of the Tx RS (SSBs), and different Tx and Rx beams, e.g., different numbers of beams and/or beam directions for the Tx and Rx beams. The number of repetitions of an SSB mini burst (e.g., SSB mini burst 602, SSB mini burst 604, SSB mini burst 606, SSB mini burst 702, SSB mini burst 704, or SSB mini burst 706) including each Tx RS transmitted via a corresponding Tx beam may be based on the number of Rx beams associated with the synchronization and BM session (e.g., per hop synchronization and BM session 601 or per hop synchronization and BM session 701).

The length of an SSB mini burst (corresponding to SSB mini burst duration 620 and/or SSB mini burst duration 720) may be based on a number of Tx RS and separation between Tx RS, while the length of the per hop synchronization and BM session 601 or 701 may be based on the length of an SSB mini burst, a number of SSB mini bursts, and a time gap (e.g., time gap 603, time gap 605, time gap 703, or time gap 707). The time gap, in some aspects, may be based on the worst case subTHz ΔTO (e.g., min ΔTO 622, min ΔTO 722, max ΔTO 624, or max ΔTO 724) discussed in relation to FIG. 5 and a Rx beam switch time (Rx beam switch time 640 or beam switch time 740), such that the time gap is equal to the min ΔTO 622/722 plus the max ΔTO 624/724 plus the Rx beam switch time 640/740 (e.g., 2 times the worst case subTHz ΔTO plus the Rx beam switch time 640/740, when the min ΔTO 622/722 and the max ΔTO 624/724 are equal). The time gap 603, 605, 703, or 707 may be used to accommodate and/or account for a maximum time uncertainty related to a coarse subTHz timing determined based on PCell timing (difference between PCell timeline used as a coarse timing for subTHz and the actual subTHz timing) and Rx beam switching time. The insertion of this time gap, in some aspects, may account for time to perform a “safe” Rx beam hypothesis testing per SSB mini burst and/or dedicated synchronization and BM RS block.

After the Tx node (e.g., base station 610 or Tx hop 710) transmits the configured Tx RS and the Rx node (e.g., UE 630 or Rx hop 730) receives the Tx RS (successfully), the Rx node may transmit a synchronization report as described in relation to FIG. 5 and a BM report (BM report 657 or BM report 757) over a PCell link to the same node (e.g., base station 610 or base station 705) from which it receives the configuration for the per hop synchronization and BM session 601 and/or 701. The report, in some aspects, may provide a list of a few best Tx beam indexes (beam IDs) from the list of beam indexes (e.g., beam indexes associated with Tx beams 611-615 or 711-715) addressed in, and/or associated with, the synchronization and BM session along with a corresponding (maximum or set of) RSRP and/or RSSI measurements for each Tx beam. Based on the report (and similar reports from other nodes/hops in a multi-hop SCell/subTHz link), a base station may configure a Tx beam for every hop of the established multi hop subTHz link before starting a data offloading session on the SCell/subTHz link. In some aspects, the corresponding Rx beam for each configured Tx beam may be determined on, or by, each receiving node of the multi hop SCell/subTHz link based on Tx-Rx beams association already known on every Rx node after synchronization and BM sessions.

If there was no successful detection, then an “in sync” indication associated with the BM report 657 or 757 (e.g., synchronization report 557) may be set to zero and the sync session for this hop will be repeated with some modified session parameters (e.g., swept Tx beams range, modified Rx beams list, increased time uncertainty range configuration, increased Tx power, different RBs for NB synchronization and BM RS transmissions). The synchronization and BM sessions, in some aspects, may be repeated for a particular set of hops (or link) until a failure criteria has been met or a successful synchronization is reported. After a successful synchronization and BM session 601 and/or 701, the current (or addressed) link should acquire a local subTHz timing and a Tx-Rx beam pair for the subTHz link. The best Tx beams, in some aspects, may be reported to a base station and the associated Rx beams will be stored locally on the Rx node side and may be used based on a known linkage/association (e.g., associated with a transmission configuration indication (TCI) and/or quasi-colocation (QCL)) with a Tx beam configured by a base station per node for subTHz based data offloading via a multi hop link (Tx-Rx beams associations, in some aspects, may be the same as in 5G NR). The estimated fine timing, in some aspects, may be followed on the Rx node side to keep synchronization for subTHz DL (for short data offloading session there may be no additional time offset estimation or a synchronization and BM session).

In some aspects, synchronization and BM sessions for different nodes/hops may be scheduled sequentially, hop after hop, in a DL direction (from a source node to a destination node for DL communication. Intermediate hops, in some aspects, may be scheduled after each previous hop reports being in sync. The scheduling and/or configuration of synchronization and BM sessions for different nodes/hops may be node- and/or hop-specific such that different synchronization and BM sessions for different nodes/hops may be associated with different local timing and/or RS or beam configurations. While, each synchronization and BM session configuration is largely independent of the previous synchronization and BM session configuration, the previous synchronization and BM session configuration may be used, in some aspects, to derive some characteristics and/or parameters for one or more subsequent synchronization and BM session configurations (e.g., a local subTHz ΔTO for a previous hop may be used to determine a scheduling for a synchronization and BM session for a subsequent hop). As discussed above in relation to subTHz synchronization session of diagram 500, a (synchronization and) BM session may be scheduled for each SCell/subTHz link activation, upon the SCell/subTHz link being active for a threshold time period (e.g., on a periodic or quasi-periodic basis) for a relatively long-lasting active session, or on an event-driven basis during the active data offloading session (e.g., upon link failure detected by an change to a communication characteristic such as an RSRP, RSSI, BER, or other indicator of link degradation below a threshold quality).

The method and apparatus described above, which does not rely on “always on” signal (SSB) transmission (e.g., existing SSB transmissions with periodicity of 20 ms) for subTHz timing and beam acquisition may reduce network power consumption, reduce initial acquisition latency (by scheduling RS or SSB for subTHz synchronization and BM on demand), avoid UE association ambiguity (by having a base station control, and be aware of, each hop in a multi-hop link), avoid SSB scalability issues by configuring RS or SSB for different links differently (with different associated codes or beam directions), and/or allow generic support for multi hop links with an unlimited or unrestricted number of smart repeaters (allowing an extended range/mesh topology). In addition to reduced latency based on on-demand RS or SSB scheduling, the initial acquisition latency may be reduced based on reducing a search space in time, frequency, and beam direction based on known characteristics of existing links for a PCell or connection/link with one or more of the Tx node and Rx node for a hop associated with a first frequency band.

For example, according to some aspects of the disclosure, synchronization and BM session may be able to provide an initial acquisition based on a partial functionality and/or scope compared to a regular initial acquisition. A synchronization and BM session, in some aspects, may not be associated with a search based on multiple PCI hypotheses search since the N_IDs/PCI for subTHz may be configured over a PCell link. Correspondingly, a method and apparatus in accordance with some aspects of the disclosure may avoid the use of both PSS and SSS, and instead may use a known sequence RS to be detected on one of the beam hypotheses to acquire timing and Tx+Rx beam pair for subTHz. In addition, some aspects may avoid the transmission of complete MIB data over the subTHz as Tx beam index information may be sufficient to be indicated coupled to a subTHz physical beam hypothesis while the rest of the control information may be provided over a PCell link. Correspondingly, PBCH allocation and decoding procedures may be simplified. In some aspects, an SSB mini burst having the same SSB structure/waveform as is currently defined in 5G NR may still be used (for some legacy/backward compatibility related considerations or in favor of a unified SSB design concept) but with a custom selection of beams list per subTHz hop/sync session scheduling. However, in some aspects, a simplified SSB mini burst processing may be done on the Rx node side even when using a legacy SSB structure/waveform in order to derive the reduced set of parameters (time sync, Tx-Rx beam pair, Tx beam ID) for establishing the subTHz link.

A UE association ambiguity, e.g., where it may not be clear if a UE that camped on a periodic “always on” SSB is connected to a base station directly or via some repeater that “forwarded” (repeated or relayed) the SSB to the UE, may be avoided because each active subTHz connection/hop is fully controlled by a base station (activated, scheduled, and controlled synchronization and BM session per hop from the base station with a corresponding linked report/response from the Rx side node that eliminates any association uncertainty). For smart repeaters (e.g., RP or AP), different known sequence RS may be used by different smart repeaters to allow multiple smart repeaters to participate in one or more SCell/subTHz links without interfering with each other. For example, in some aspects associated with a deployment of large numbers of repeaters, SSB occasions for multiple repeaters may be preserved using the different known sequence RS.

As described above in relation to FIGS. 5-7, a customized per hop configuration/scheduling for a synchronization and BM session may define/control a synchronization session start time (by referring to PCell timeline) for Tx and Rx sides of the addressed hop, a custom SSB mini burst/dedicated synchronization and BM RS configuration, and/or a link (or resources to use) for reporting the results from the customized per hop configuration/scheduling for a synchronization and BM session. The custom SSB mini burst/dedicated synchronization and BM RS configuration, in some aspects, may include a number of the swept Tx beams in a beams burst/block, an angular Tx sector/span configuration for the Tx node of the addressed hop to be covered by Tx beam sweep around a known coarse Tx beam direction, a coarse Tx and Rx beam direction indication, a number of repetitions of SSB mini bursts/dedicated synchronization and BM RS blocks, and/or a time gap configuration between the repetitions of SSB mini bursts/dedicated synchronization and BM RS blocks.

The process described above in relation to FIGS. 5-7 may be the same for all link types/hops (e.g., base station-UE, base station-RP, RP-AP, AP-UE) while the RX side is always reporting its synchronization and BM session report to the base station over the PCell link (even in cases where the base station is not the Tx side node of the addressed hop). Correspondingly, for data transmission over a multi hop subTHz link, all the beam control and scheduling information or other control data for all the involved nodes including smart repeaters may be provided by a base station over a PCell link.

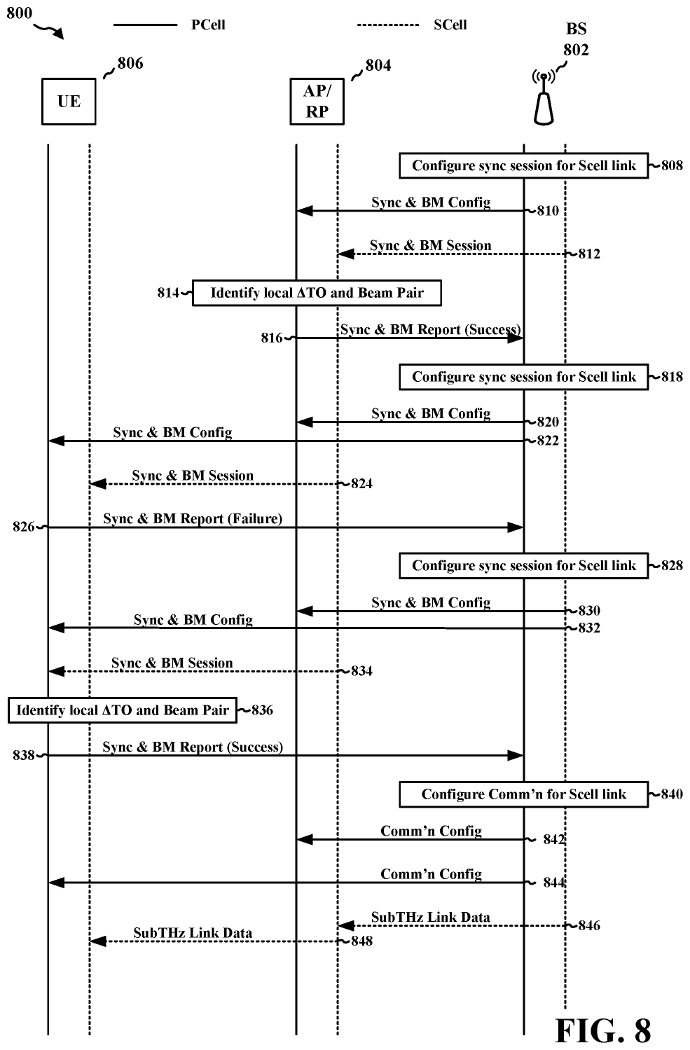

FIG. 8 is a call low diagram 800 illustrating operations associated with a set of synchronization and BM sessions for a multi-hop SCell/subTHz link in accordance with some aspects of the disclosure. in accordance with some aspects of the disclosure. Diagram 800 begins, at 808, with a base station 802 configuring a synchronization and BM session for a subTHz link with an AP/RP 804. In some aspects, the base station 802 may configure the synchronization and BM session at 808 based on one or more of an SCell/subTHz link activation, threshold time passing since a last synchronization and BM session associated with an active SCell/subTHz link with the AP/RP 804, or a degradation and/or failure of an active SCell/subTHz link with the AP/RP 804.

The configured synchronization and BM session may include a set of parameters relating to one or more of a set of timing parameters and a set of RS (or BM/BR) parameters. The set of timing parameters, in some aspects, may include a first timing indication (e.g., a first value) based on a first timing unit associated with the PCell. The set of timing parameters, in some aspects, may also include a second timing indication (e.g., a second value) based on a second timing unit associated with the SCell/subTHz as described in relation to FIG. 5. The first and second timing indications may relate to an expected timing (e.g., a beginning) of the synchronization and BM session. The set of timing parameters, in some aspects, may further indicate an estimated (maximum) timing offset for extending a synchronization and BM session monitoring at an Rx device (e.g., AP/RP 804) by adding the estimated (maximum) timing offset before and after an indicated expected timing of the synchronization and BM session.

The set of RS (or BM/BR) parameters, in some aspects, may include one or more of a sequence (e.g. a sequence ID, parameters, and/or PCI) associated with the RS in a set of RS associated with the synchronization and BM session, a frequency associated with the RS in the set of RS, a set of transmission resources (e.g., time-and-frequency resources and/or beam directions) associated with the RS in the set of RS, or a set of reception resources (e.g., beam directions) associated with the RS in the set of RS. In some aspects, the set of transmission resources and the set of reception resources each include a set of beams (e.g., the set of Tx beams 611-615 or 711-715 and/or Rx beams 632-636 or 732-736 of FIGS. 6 and 7). The set of transmission resources (Tx beams), in some aspects, may be based on at least one transmission associated with the first frequency band resource (e.g., a Tx beam in a Tx-beam-Rx beam pair for a PCell link). In some aspects, the set of reception resources are based on at least one reception resource associated with the first frequency band (e.g., a Rx beam in a Tx-beam-Rx beam pair for the PCell link). In some aspects, at least one of the set of transmission resources or the set of reception resources are indicated via one of a set of indexes, identifiers, or a set of angular values indicating one of a corresponding directionality or orientation. As discussed above in relation to FIGS. 6 and 7, the set of RS associated with the synchronization and BM session may include a modified SSB configured for the synchronization and BM session with the wireless device based on the set of configuration parameters. In some aspects, the modified SSB may carry less information than an unmodified SSB on the first frequency band (e.g., a standard SSB for initial acquisition associated with the PCell link).

Based on the synchronization and BM session parameters configured at 808, the base station 802 may transmit, and AP/RP 804 (or a UE for a single hop implementation) may receive, synchronization and BM configuration 810. The synchronization and BM configuration 810, in some aspects, may include one or more of a third indication of the sequence associated with RS in the set of RS associated with the synchronization session, a fourth indication of frequency associated with the RS in the set of RS, a fifth indication of a set of transmission resources associated with the RS in the set of RS, or a sixth indication of a set of reception resources associated with the RS in the set of RS. In some aspects, a first component associated with the base station 802 may configure the parameters at 808 and output the configuration to a TRP associated with the PCell link for transmission to the AP/RP 804 and to a TRP associated with the activated SCell link to configure a set of transmissions associated with a synchronization and BM session 812.

Based on the synchronization and BM configuration 810, the base station 802 may transmit, and AP/RP 804 may receive, a set of RS (or other transmissions) associated with the synchronization and BM session 812. The synchronization and BM session 812, in some aspects, may be transmitted via a second frequency band associated with the SCell/subTHz link. In some aspects, the synchronization and BM session 812 may include a set of RS including a first subset of RS associated with a corresponding set of at least one of (Tx) spatial-domain resources or beams for RS transmission. The first subset of RS, in some aspects, may be associated with a first (Rx) spatial-domain resource or beam for reception of the first subset of RS and the first subset of RS is repeated (e.g., as subsequent subsets of RS) for each of a plurality of (Rx) spatial-domain resources or beams with a period that is equal to a first monitoring time plus twice the absolute value of the timing offset and a reception beam switching time as described above in relation to FIGS. 6 and 7, and more specifically to SSB mini burst 602, 604, and 606 and time gaps 603 and 605 or SSB mini burst 702, 704, and 706 and time gaps 703 and 707.

Based on the synchronization and BM session 812, the AP/RP 804 may identify and/or determine, at 814, a local subTHz ΔTO (e.g., local subTHz ΔTO 515) and may measure a signal characteristic (e.g., an RSRP and/or RSSI) associated with the RS associated with synchronization and BM session 812 used to determine a best beam pair at the base station 802 and at the AP/RP 804. In some aspects, the identification and/or determination at 814 includes determining a timing offset between a first time at which the first reference signal is transmitted from the TRP of the base station 802 associated with the SCell/subTHz link and a second time at which the first reference signal is received at the AP/RP 804 based on the first value and the second value. The timing offset (e.g., the local subTHz ΔTO 515), in some aspects, may be used to synchronize the AP/RP 804 and the base station 802 (or the SCell TRP of the base station 802) for, or during, a subsequent communication session (associated with subTHz link data 846 and or subTHz link data 848) corresponding to the synchronization session.

If the identification and/or determination at 814 is successful (as illustrated in diagram 800), the AP/RP 804 may report (over the PCell link) synchronization and BM report 816. In some aspects, the success of the identification and/or determination at 814 may be based on a measured signal-strength-characteristic of at least one RS in the set of RS being above a threshold value. The synchronization and BM report 816, in some aspects, may include a second indication of at least one of a synchronization state (e.g., a synchronization state of “1” indicating an in sync state based on a successful synchronization operation) and/or a beam management report (e.g., indicating a set of RS strength or quality measurements such as an RSRP and/or RSSI for at least a subset of RS) associated with the synchronization and BM session 812 for the second frequency band (e.g., the SCell/subTHz link). In some aspects, the synchronization and BM report 816 may include at least one identifier associated with at least one RS in the set of RS, where each RS (or identifier) is associated with a transmission beam (e.g. a spatial-domain resource or directionality). The synchronization and BM report 816, in some aspects, may include at least one of a third indication that the at least one RS is associated with a first value for a measured signal-strength-characteristic that is above a threshold value or a fourth indication of a second value for the measured signal-strength-characteristic. In some aspects, the at least one RS includes at least a RS associated with a highest value of the measured signal-strength-characteristic.

After a synchronization and BM session for the AP/RP 804 successfully completes, the base station 802 may configure, at 818, a synchronization and BM session for a subTHz link between the AP/RP 804 and a UE 806. The configuration may include a set of parameters relating to one or more of a set of timing parameters and a set of RS (or BM/BR) parameters. The parameters configured for the synchronization and BM session between the AP/RP 804 and the UE 806 may include one or more of the parameters discussed above in relation to the parameters configured at 808. After configuring the set of parameters for the synchronization and BM session for a subTHz link between the AP/RP 804 and a UE 806, the base station 802 may transmit, and the AP/RP 804 may receive, a first synchronization and BM configuration 820 over a PCell link between the base station 802 and the AP/RP 804. The base station 802, in some aspects, may also transmit, and UE 806 may receive, a second synchronization and BM configuration 822 over a PCell link between the base station 802 and the UE 806, where the first and second synchronization and BM configurations 820 and 822 are a coordinated set of configurations based on the known characteristics of the AP/RP 804, the UE 806, and the outcome (e.g., a local subTHz ΔTO at the AP/RP 804) of the synchronization and BM session 812. The types of information that may be considered by the base station 802 are described above in relation to FIGS. 5-7.

Based on the first and second synchronization and BM configurations 820 and 822, the AP/RP 804 may transmit, and UE 806 may receive, a set of RS associated with synchronization and BM session 824. As discussed above, the basic structure of the synchronization and BM session 824 may be similar to the structure of the synchronization and BM session 812, but the specific parameters may be different. For example, synchronization and BM session 824 may use, include, or be associated with a different number of swept Tx and/or Rx beams, a different sequence for the RS, a different maximum ΔTO and associated time gaps, or, for example, other differences as described above in relation to FIGS. 6 and 7.

For demonstrative purposes, synchronization and BM session 824 is illustrated in diagram 800 as having failed. UE 806 may transmit, and base station 802 may receive, synchronization and BM report 826 indicating a failure to synchronize. The failure to synchronize, in some aspects may be based on, e.g., a failure to detect a RS with a sufficient strength such as an RSRP and/or RSSI. The synchronization and BM report 826 may include an indication of a “0” state of the synchronization indicating that the synchronization was not successful. Accordingly, based on the synchronization and BM report 826 indicating a failure, the base station may configure, at 828, an additional synchronization and BM session with modified parameters (e.g., relating to one or more of a swept Tx beams range, a modified Rx beams list, an increased time uncertainty range configuration, an increased Tx power, and/or different RBs for NB synchronization and BM RS transmissions) as described in relation to FIGS. 6 and 7.

The updated configuration may include a set of parameters relating to one or more of a set of timing parameters and a set of RS (or BM/BR) parameters. The parameters configured for the synchronization and BM session between the AP/RP 804 and the UE 806 may include one or more of the parameters discussed above in relation to the parameters configured at 808 or 818. After configuring, at 828, the updated set of parameters for the synchronization and BM session for the subTHz link between the AP/RP 804 and a UE 806, the base station 802 may transmit, and the AP/RP 804 may receive, a third synchronization and BM configuration 830 over a PCell link between the base station 802 and the AP/RP 804. The base station 802, in some aspects, may also transmit, and UE 806 may receive, a fourth synchronization and BM configuration 832 over a PCell link between the base station 802 and the UE 806, where the third and fourth synchronization and BM configurations 830 and 832 are a coordinated set of configurations as described above for the first and second synchronization and BM configurations 820 and 822.

Based on the third and fourth synchronization and BM configurations 830 and 832, the AP/RP 804 may transmit, and UE 806 may receive, a set of RS associated with synchronization and BM session 834. As discussed above, the basic structure of the synchronization and BM session 834 may be similar to the structure of the synchronization and BM session 812 and/or 824, but the specific parameters may be different. For example, synchronization and BM session 834 may use, include, or be associated with a different number of swept Tx and/or Rx beams, a different sequence for the RS, a different maximum ΔTO and associated time gaps, or, for example, other differences as described above in relation to FIGS. 6 and 7.

As discussed above, the UE 806 may identify and/or determine, at 836, a local subTHz ΔTO (e.g., local subTHz ΔTO 515) and may measure a signal characteristic (e.g., an RSRP and/or RSSI) associated with the RS associated with synchronization and BM session 834 used to determine a best beam pair at the AP/RP 804 and the UE 806. In some aspects, the identification and/or determination at 836 includes determining a timing offset between a first time at which the first reference signal is transmitted from the TRP of the AP/RP 804 associated with the SCell/subTHz link and a second time at which the first reference signal is received at the UE 806. The timing offset (e.g., the local subTHz ΔTO 515), in some aspects, may be used to synchronize the AP/RP 804 and the UE 806 (or the SCell TRP of the UE 806) for, or during, a subsequent communication session (associated with subTHz link data 848) corresponding to the synchronization session.

If the identification and/or determination at 836 is successful (as illustrated in diagram 800), the UE 806 may report (over the PCell link) synchronization and BM report 838. In some aspects, the success of the identification and/or determination at 836 may be based on a measured signal-strength-characteristic of at least one RS in the set of RS being above a threshold value. The synchronization and BM report 838, in some aspects, may include a second indication of at least one of a synchronization state (e.g., a synchronization state of “1” indicating an in sync state based on a successful synchronization operation) and/or a beam management report (e.g., indicating a set of RS strength or quality measurements such as an RSRP and/or RSSI for at least a subset of RS) associated with the synchronization and BM session 834 for the second frequency band (e.g., the SCell/subTHz link). In some aspects, the synchronization and BM report 838 may include at least one identifier associated with at least one RS in the set of RS, where each RS (or identifier) is associated with a transmission beam (e.g. a spatial-domain resource or directionality). The synchronization and BM report 838, in some aspects, may include at least one of a third indication that the at least one RS is associated with a first value for a measured signal-strength-characteristic that is above a threshold value or a fourth indication of a second value for the measured signal-strength-characteristic. In some aspects, the at least one RS includes at least a RS associated with a highest value of the measured signal-strength-characteristic. While discussed in the context of a next hop that is a destination/final hop, the second set of operations for the second synchronization and BM process (e.g., 818-838) may be performed for each intermediate hop in a multi-hop subTHz link.

After each hop in a multi-hop subTHz link has been synchronized, the base station 802, may configure, at 840, a set of communication parameters such as identifying time-and-frequency resources (e.g., RBs or other resource allocation units) and/or Tx-Rx beam pairs. In some aspects, Tx beams may be configured by the base station 802 while corresponding Rx beams are determined by each node based on the measurements performed in association with a synchronization and BM session. After configuring the communication parameters, the base station 802 may transmit, and the AP/RP 804 and UE 806 may receive, communication configuration 842 and communication configuration 844, respectively. Once the communication configurations 842 and 844 have been received the base station 802 may transmit, and AP/RP 804 may receive, subTHz link data 846 that may then be transmitted (e.g., relayed and/or repeated) by the AP/RP 804 as subTHz link data 848 and may be received by UE 806, where the subTHz link data 846 and 848 are transmitted and/or received based on the communication configurations 842 and 844.

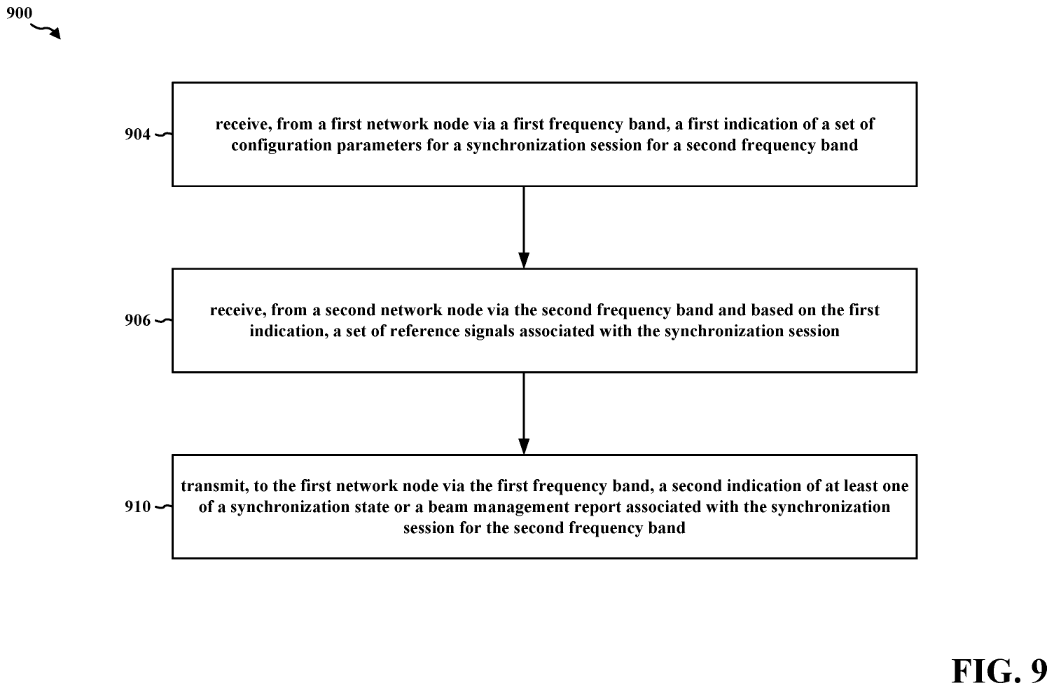

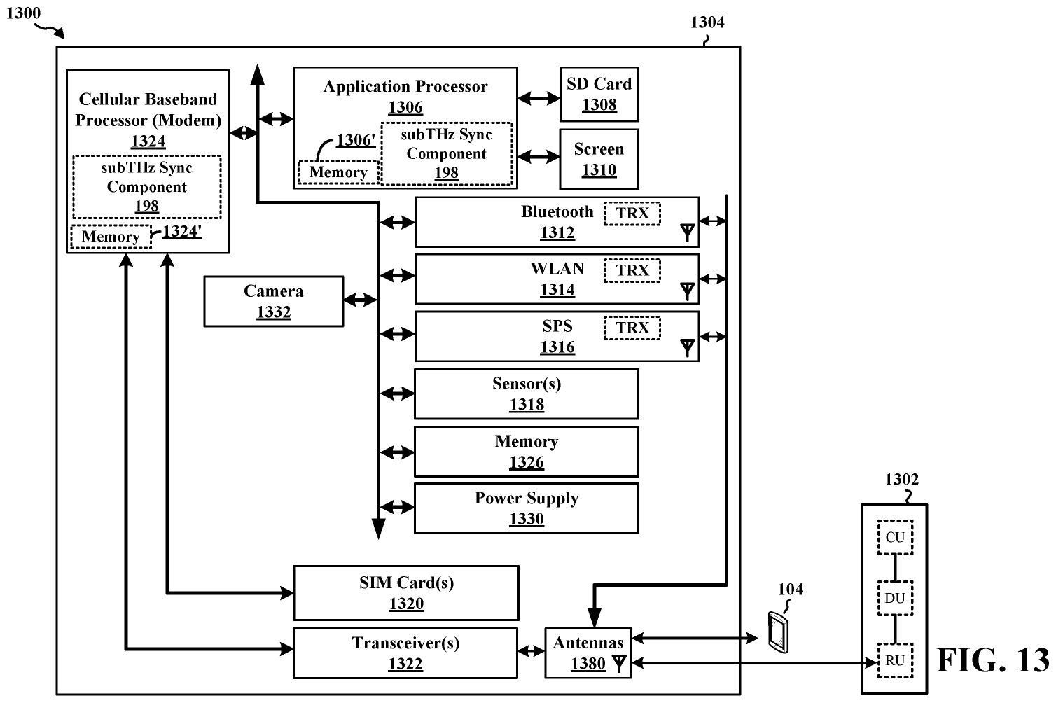

FIG. 9 is a flowchart 900 of a method of wireless communication. The method may be performed by a UE (e.g., the UE 94, 404, 424, 442, 630, or 806; the apparatus 1304). At 904, the UE may receive, from a first network node via a first frequency band, a first indication of a set of configuration parameters for a synchronization session for a second frequency band. For example, 904 may be performed by application processor 1306, cellular baseband processor 1324, transceiver(s) 1322, antenna(s) 1380, or subTHz sync component 198 of FIG. 13. In some aspects, the UE may receive or transmit a request for a communication session via the second (e.g., subTHz) frequency band that triggers the reception, at 904, of the first indication of the set of configuration parameters for the synchronization session for the second frequency band.

The set of configuration parameters, in some aspects, may include one or more of a third indication of a sequence associated with reference signals in a set of reference signals associated with the synchronization session, a fourth indication of frequency associated with the reference signals in the set of reference signals, a fifth indication of a set of transmission resources associated with the reference signals in the set of reference signals, or a sixth indication of a set of reception resources associated with the reference signals in the set of reference signals. In some aspects, the set of transmission resources and the set of reception resources may include a set of beams, and the set of transmission resources may be based on at least one transmission resource associated with the first frequency band (e.g., a Tx beam of a PCell link associated with the first frequency band), and the set of reception resources are based on at least one reception resource associated with the first frequency band (e.g., an Rx beam of the PCell link). At least one of the set of transmission resources or the set of reception resources, in some aspects, may be indicated via one of a set of indexes, identifiers, or a set of angular values indicating one of a corresponding directionality or orientation. In some aspects, the set of reference signals includes a modified SSB configured for the synchronization session with the wireless device based on the set of configuration parameters, where the modified SSB carries less information than an unmodified SSB on the first frequency band. For example, referring to FIGS. 5-8 the base station 550, 610, 705, or 802, may transmit, and the second device 511, the UE 630, the Rx hop 730, or the UE 806 may receive, sync session scheduling 555, sync session scheduling 655, sync session scheduling 755 or synchronization and BM configurations 822 or 832.

In some aspects, the first indication may indicate a time associated with a first reference signal in the set of reference signals. The time associated with the first reference signal, in some aspects, may be indicated based on a first value associated with a first unit of time associated with communication via the first frequency band and a second value associated with a second unit of time associated with communication via the second frequency band. In some aspects, the first unit of time may be larger than the second unit of time. In some aspects, the first indication further indicates an estimated maximum for an absolute value of the timing offset that is added before a beginning and after an end of a first monitoring time, where the first monitoring time begins at a time based on the first time at which the first reference signal is transmitted from the second network node and spans a time configured for a transmission of a plurality of reference signals in the set of reference signals.

At 906, the UE may receive from a second network node via the second frequency band and based on the first indication, a set of reference signals associated with the synchronization session. For example, 906 may be performed by application processor 1306, cellular baseband processor 1324, transceiver(s) 1322, antenna(s) 1380, or subTHz sync component 198 of FIG. 13. In some aspects, the set of reference signals includes a first subset of reference signals associated with a corresponding set of at least one of spatial-domain resources or beams for reference signal transmission. The first subset of reference signals, in some aspects, may be associated with at least one of a first spatial-domain resource or beam for reception of the first subset of reference signals and the first subset of reference signals is repeated for each of a plurality of spatial-domain resources or beams with a period that is equal to the first monitoring time plus twice the absolute value of the timing offset and a reception beam switching time. For example, referring to FIGS. 5-8, the second device 511, UE 630, Rx hop 730, or UE 806 may receive the RS associated with synchronization and BM session transmissions 503, 513, synchronization and BM session 601, 701, or synchronization and BM session 824 or 834.

Based on the set of reference signals associated with the synchronization session the UE may determine a timing offset between a first time at which the first reference signal is transmitted from the second network node and a second time at which the first reference signal is received at the wireless device based on the first value and the second value. In some aspects, the timing offset may be used to synchronize the wireless device and the second network node during a subsequent communication session corresponding to the synchronization session. For example, referring to FIGS. 5 and 8, the second device 511 or the UE 806 may determine, at 814, a local subTHz ΔTO 515.

At 910, the UE may transmit, to the first network node via the first frequency band, a second indication of at least one of a synchronization state or a beam management report associated with the synchronization session for the second frequency band. For example, 910 may be performed by application processor 1306, cellular baseband processor 1324, transceiver(s) 1322, antenna(s) 1380, or subTHz sync component 198 of FIG. 13. The synchronization state may indicate whether the UE was successful in determining the local offset time (e.g., local subTHz ΔTO 515) based on the RS received at 906. The beam management report, in some aspects, may include an indication that that a value for a measured signal-strength-characteristic (e.g., RSRP and/or RSSI) of the set of reference signals is above a threshold value. In some aspects, beam management report may include at least one identifier associated with at least one reference signal in the set of reference signals, where each reference signal is associated with a transmission beam (or a Tx-Rx beam pair). The beam management report, in some aspects, may include at least one of a third indication that the at least one reference signal is associated with a first value for a measured signal-strength-characteristic that is above a threshold value or a fourth indication of a second value for the measured signal-strength-characteristic. In some aspects, the at least one reference signal includes at least a reference signal associated with a highest value of the measured signal-strength-characteristic. For example, referring to FIGS. 5-8, the second device 511, UE 630, Rx hop 730, or UE 806 may transmit, and the base station 550, 610, 705, or 802, may receive synchronization (and BM) report 557, BM report 657 or 757, or synchronization and BM report 838.

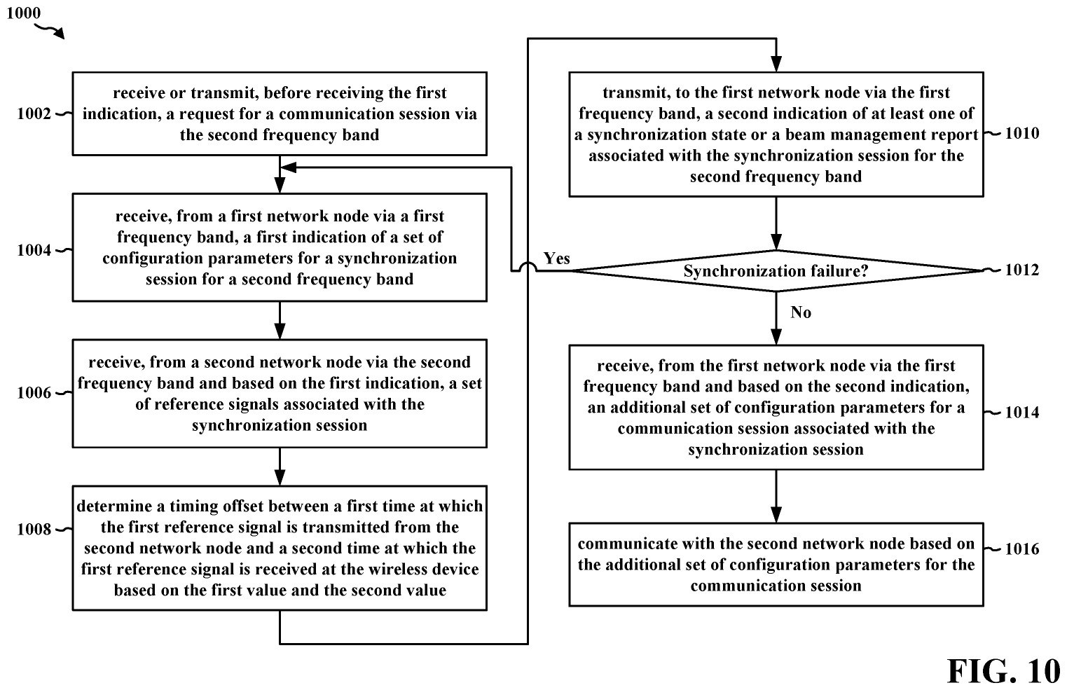

FIG. 10 is a flowchart 1000 of a method of wireless communication. The method may be performed by a UE (e.g., the UE 104, 404, 424, 442, 630, or 806; the apparatus 1304). At 1002, the UE may receive or transmit a request for a communication session via a second (e.g., subTHz) frequency. For example, 1002 may be performed by application processor 1306, cellular baseband processor 1324, transceiver(s) 1322, antenna(s) 1380, or subTHz sync component 198 of FIG. 13. The request, in some aspects, may be associated with a subTHz synchronization and BM session. For example, referring to FIGS. 5-8, a request for a communication via the second frequency band may trigger the synchronization and BM session 812 (or the configuration at 808) or synchronization and BM sessions of diagrams 500, 600, and 700.

At 1004, the UE may receive, from a first network node via a first frequency band, a first indication of a set of configuration parameters for a synchronization session for a second frequency band. For example, 1004 may be performed by application processor 1306, cellular baseband processor 1324, transceiver(s) 1322, antenna(s) 1380, or subTHz sync component 198 of FIG. 13. The set of configuration parameters, in some aspects, may include one or more of a third indication of a sequence associated with reference signals in a set of reference signals associated with the synchronization session, a fourth indication of frequency associated with the reference signals in the set of reference signals, a fifth indication of a set of transmission resources associated with the reference signals in the set of reference signals, or a sixth indication of a set of reception resources associated with the reference signals in the set of reference signals. In some aspects, the set of transmission resources and the set of reception resources may include a set of beams, and the set of transmission resources may be based on at least one transmission resource associated with the first frequency band (e.g., a Tx beam of a PCell link associated with the first frequency band), and the set of reception resources are based on at least one reception resource associated with the first frequency band (e.g., an Rx beam of the PCell link). At least one of the set of transmission resources or the set of reception resources, in some aspects, may be indicated via one of a set of indexes, identifiers, or a set of angular values indicating one of a corresponding directionality or orientation. In some aspects, the set of reference signals includes a modified SSB configured for the synchronization session with the wireless device based on the set of configuration parameters, where the modified SSB carries less information than an unmodified SSB on the first frequency band. For example, referring to FIGS. 5-8 the base station 550, 610, 705, or 802, may transmit sync session scheduling 555, sync session scheduling 655, sync session scheduling 755 or synchronization and BM configurations 822 or 832.

In some aspects, the first indication may indicate a time associated with a first reference signal in the set of reference signals. The time associated with the first reference signal, in some aspects, may be indicated based on a first value associated with a first unit of time associated with communication via the first frequency band and a second value associated with a second unit of time associated with communication via the second frequency band. In some aspects, the first unit of time may be larger than the second unit of time. In some aspects, the first indication further indicates an estimated maximum for an absolute value of the timing offset that is added before a beginning and after an end of a first monitoring time, where the first monitoring time begins at a time based on the first time at which the first reference signal is transmitted from the second network node and spans a time configured for a transmission of a plurality of reference signals in the set of reference signals.

At 1006, the UE may receive from a second network node via the second frequency band and based on the first indication, a set of reference signals associated with the synchronization session. For example, 1006 may be performed by application processor 1306, cellular baseband processor 1324, transceiver(s) 1322, antenna(s) 1380, or subTHz sync component 198 of FIG. 13. In some aspects, the set of reference signals includes a first subset of reference signals associated with a corresponding set of at least one of spatial-domain resources or beams for reference signal transmission. The first subset of reference signals, in some aspects, may be associated with at least one of a first spatial-domain resource or beam for reception of the first subset of reference signals and the first subset of reference signals is repeated for each of a plurality of spatial-domain resources or beams with a period that is equal to the first monitoring time plus twice the absolute value of the timing offset and a reception beam switching time. For example, referring to FIGS. 5-8, the second device 511, UE 630, Rx hop 730, or UE 806 may receive the RS associated with synchronization and BM session transmissions 503, 513, synchronization and BM session 601, 701, or synchronization and BM session 824 or 834.

At 1008, the UE may determine a timing offset between a first time at which the first reference signal is transmitted from the second network node and a second time at which the first reference signal is received at the wireless device based on the first value and the second value. For example, 1008 may be performed by application processor 1306, cellular baseband processor 1324, transceiver(s) 1322, antenna(s) 1380, or subTHz sync component 198 of FIG. 13. In some aspects, the timing offset may be used to synchronize the wireless device and the second network node during a subsequent communication session corresponding to the synchronization session. For example, referring to FIGS. 5 and 8, the second device 511 or the UE 806 may determine, at 814, a local subTHz ΔTO 515.

At 1010, the UE may transmit, to the first network node via the first frequency band, a second indication of at least one of a synchronization state or a beam management report associated with the synchronization session for the second frequency band. For example, 1010 may be performed by application processor 1306, cellular baseband processor 1324, transceiver(s) 1322, antenna(s) 1380, or subTHz sync component 198 of FIG. 13. The synchronization state may indicate whether the UE was successful in determining the local offset time (e.g., local subTHz ΔTO 515) based on the RS received at 1006. The beam management report, in some aspects, may include an indication that that a value for a measured signal-strength-characteristic (e.g., an RSRP and/or RSSI) of the set of reference signals is above a threshold value. In some aspects, beam management report may include at least one identifier associated with at least one reference signal in the set of reference signals, where each reference signal is associated with a transmission beam (or a Tx-Rx beam pair). The beam management report, in some aspects, may include at least one of a third indication that the at least one reference signal is associated with a first value for a measured signal-strength-characteristic that is above a threshold value or a fourth indication of a second value for the measured signal-strength-characteristic. In some aspects, the at least one reference signal includes at least a reference signal associated with a highest value of the measured signal-strength-characteristic. For example, referring to FIGS. 5-8, the second device 511, UE 630, Rx hop 730, or UE 806 may transmit, and the base station 550, 610, 705, or 802, may receive synchronization (and BM) report 557, BM report 657 or 757, or synchronization and BM report 838.

At 1012, the UE may determine if a synchronization and BM session has failed. For example, 1012 may be performed by application processor 1306, cellular baseband processor 1324, or subTHz sync component 198 of FIG. 13. In some aspects, the determination may be made based on a same set of operations that generate the second indication of the synchronization state and/or beam management report. For example, referring to FIG. 8, the UE 806 may fail to synchronize based on synchronization and BM session 824. Based on the failure to synchronize, the UE may return to 1004 to receive a third indication of a second set of configuration parameters for a second synchronization session for the second frequency band and proceed to 1006 to receive, from the second network node via the second frequency band, a second set of reference signals associated with the second synchronization session.

If the UE determines, at 1012, that the synchronization and BM session was successful, the UE may proceed to 1014, and receive, from the first network node via the first frequency band and based on the second indication, an additional set of configuration parameters for a communication session associated with the synchronization session. For example, 1014 may be performed by application processor 1306, cellular baseband processor 1324, transceiver(s) 1322, antenna(s) 1380, or subTHz sync component 198 of FIG. 13. The additional set of configuration parameters for the communication session, in some aspects, may include time-and-frequency resources (e.g., RBs or other resource allocation units) and/or Tx-Rx beam pairs. In some aspects, the additional set of configuration parameters for the communication session may include a sixth indication indicating at least one identifier included in the beam management report, where the second network node is configured to use, for a data transmission associated with the communication session with the wireless device, at least one transmission beam associated with the at least one identifier included in the beam management report. For example, referring to FIG. 8, the UE 806 may receive, and base station 802 may transmit, communication configuration 844.

At 1016, the UE may communicate with the second network based on the additional set of configuration parameters for the communication session. For example, 1016 may be performed by application processor 1306, cellular baseband processor 1324, transceiver(s) 1322, antenna(s) 1380, or subTHz sync component 198 of FIG. 13. In some aspects, the communication with the second network node may be as a relay or repeater from a base station. The UE may communicate, as part of a communication session, with the second network node via the second frequency band using at least one reception beam based on the at least one identifier indicated in the sixth indication associated with the at least one transmission beam which the second network node is configured to use for the data transmission associated with the communication session. For example, referring to FIG. 8, the UE 806 may communicate (e.g., receive subTHz link data 848) from the AP/RP 804 based on the set of configuration parameters for the communication session included in communication configuration 844.

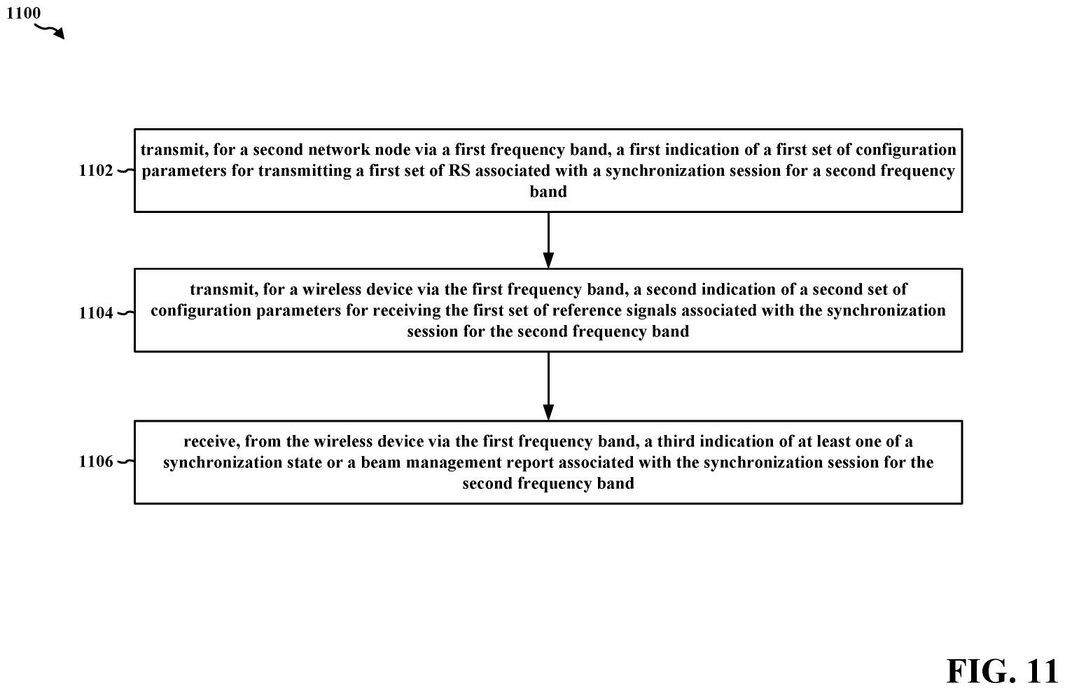

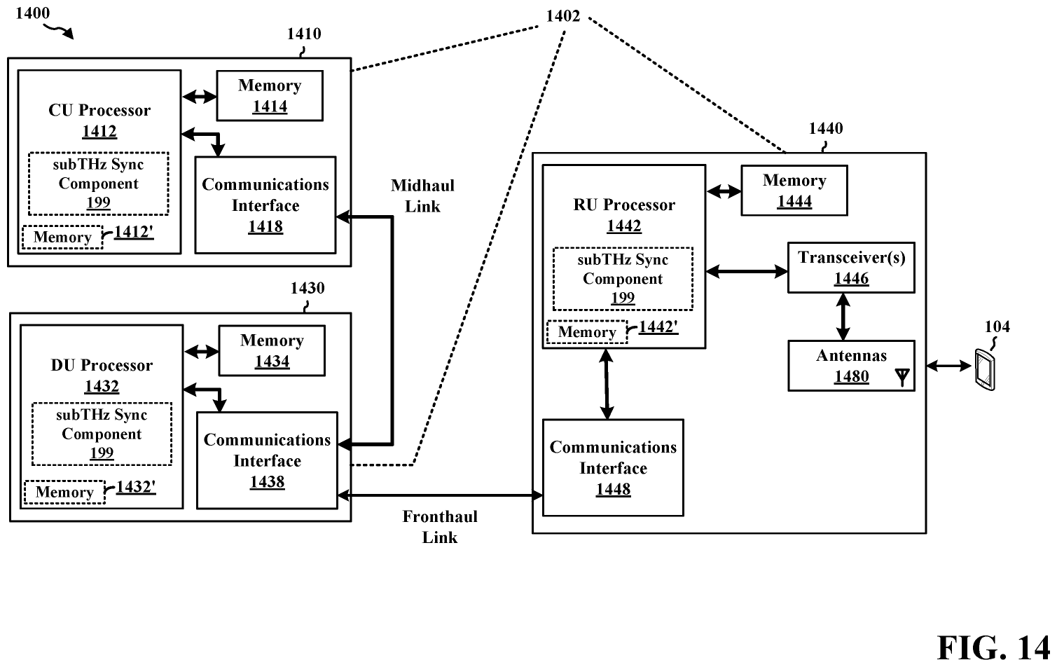

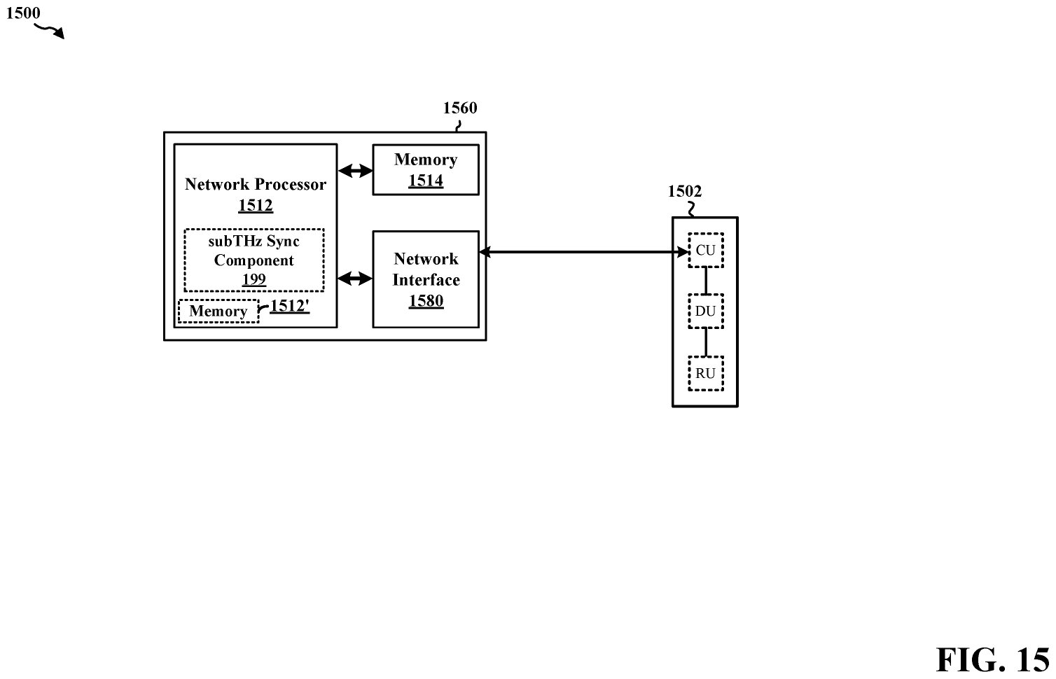

FIG. 11 is a flowchart 1100 of a method of wireless communication. The method may be performed by a base station (e.g., the base station 102, 402 550, 610, 705, or 802; the network entity 1302, 1402, or 1560). At 1102, the base station may transmit, for a second network node via a first frequency band, a first indication of a first set of configuration parameters for transmitting a first set of reference signals associated with a synchronization session for a second frequency band. For example, 1102 may be performed by CU processor 1412, DU processor 1432, RU processor 1442, transceiver(s) 1446, antenna(s) 1480, network interface 1580, network processor 1512, or subTHz sync component 199 of FIG. 14 or 15. In some aspects, the transmission of the first indication may be based on a request for a communication session via the second (e.g., subTHz) frequency band. The set of configuration parameters, in some aspects, may include one or more of a third indication of a sequence associated with reference signals in a set of reference signals associated with the synchronization session, a fourth indication of frequency associated with the reference signals in the set of reference signals, a fifth indication of a set of transmission resources associated with the reference signals in the set of reference signals, or a sixth indication of a set of reception resources associated with the reference signals in the set of reference signals. In some aspects, the set of transmission resources and the set of reception resources may include a set of beams, and the set of transmission resources may be based on at least one transmission resource associated with the first frequency band (e.g., a Tx beam of a PCell link associated with the first frequency band), and the set of reception resources are based on at least one reception resource associated with the first frequency band (e.g., an Rx beam of the PCell link). At least one of the set of transmission resources or the set of reception resources, in some aspects, may be indicated via one of a set of indexes, identifiers, or a set of angular values indicating one of a corresponding directionality or orientation. In some aspects, the set of reference signals includes a modified SSB configured for the synchronization session with the wireless device based on the set of configuration parameters, where the modified SSB carries less information than an unmodified SSB on the first frequency band. For example, referring to FIGS. 5-8 the base station 550, 610, 705, or 802, may transmit sync session scheduling 553, sync session scheduling 755, or synchronization and BM configurations 820 or 830.

In some aspects, the first indication may indicate a time associated with a first reference signal in the set of reference signals. The time associated with the first reference signal, in some aspects, may be indicated based on a first value associated with a first unit of time associated with communication via the first frequency band and a second value associated with a second unit of time associated with communication via the second frequency band. In some aspects, the first unit of time may be larger than the second unit of time. In some aspects, the first indication further indicates an estimated maximum for an absolute value of the timing offset that is added before a beginning and after an end of a first monitoring time, where the first monitoring time begins at a time based on the first time at which the first reference signal is transmitted from the second network node and spans a time configured for a transmission of a plurality of reference signals in the set of reference signals.

At 1104, the base station may transmit, for a wireless device via the first frequency band, a second indication of a second set of configuration parameters for receiving the first set of reference signals associated with the synchronization session for the second frequency band. For example, 1104 may be performed by CU processor 1412, DU processor 1432, RU processor 1442, transceiver(s) 1446, antenna(s) 1480, network interface 1580, network processor 1512, or subTHz sync component 199 of FIG. 14 or 15. The second indication may include a similar set of parameters as the first indication to coordinate the second network node and the wireless device. For example, referring to FIGS. 5-8 the base station 550, 610, 705, or 802, may transmit sync session scheduling 555, sync session scheduling 655, sync session scheduling 755 or synchronization and BM configurations 822 or 832.

At 1106, the base station may receive, from the wireless device via the first frequency band, a third indication of at least one of a synchronization state or a beam management report associated with the synchronization session for the second frequency band. For example, 1106 may be performed by CU processor 1412, DU processor 1432, RU processor 1442, transceiver(s) 1446, antenna(s) 1480, network interface 1580, network processor 1512, or subTHz sync component 199 of FIG. 14 or 15. The synchronization state may indicate whether the wireless device was successful in determining a local offset time (e.g., local subTHz ΔTO 515) based on the RS received from the second network node. The beam management report, in some aspects, may include an indication that that a value for a measured signal-strength-characteristic (e.g., an RSRP and/or RSSI) of the set of reference signals is above a threshold value. In some aspects, the beam management report may include at least one identifier associated with at least one reference signal in the set of reference signals, where each reference signal is associated with a transmission beam (or a Tx-Rx beam pair). The beam management report, in some aspects, may include at least one of (1) an indication that the at least one reference signal is associated with a first value for a measured signal-strength-characteristic that is above a threshold value or (2) an indication of a second value for the measured signal-strength-characteristic. In some aspects, the at least one reference signal includes at least a reference signal associated with a highest value of the measured signal-strength-characteristic. For example, referring to FIGS. 5-8, the second device 511, UE 630, Rx hop 730, or UE 806 may transmit, and the base station 550, 610, 705, or 802, may receive synchronization (and BM) report 557, BM report 657 or 757, or synchronization and BM report 838.

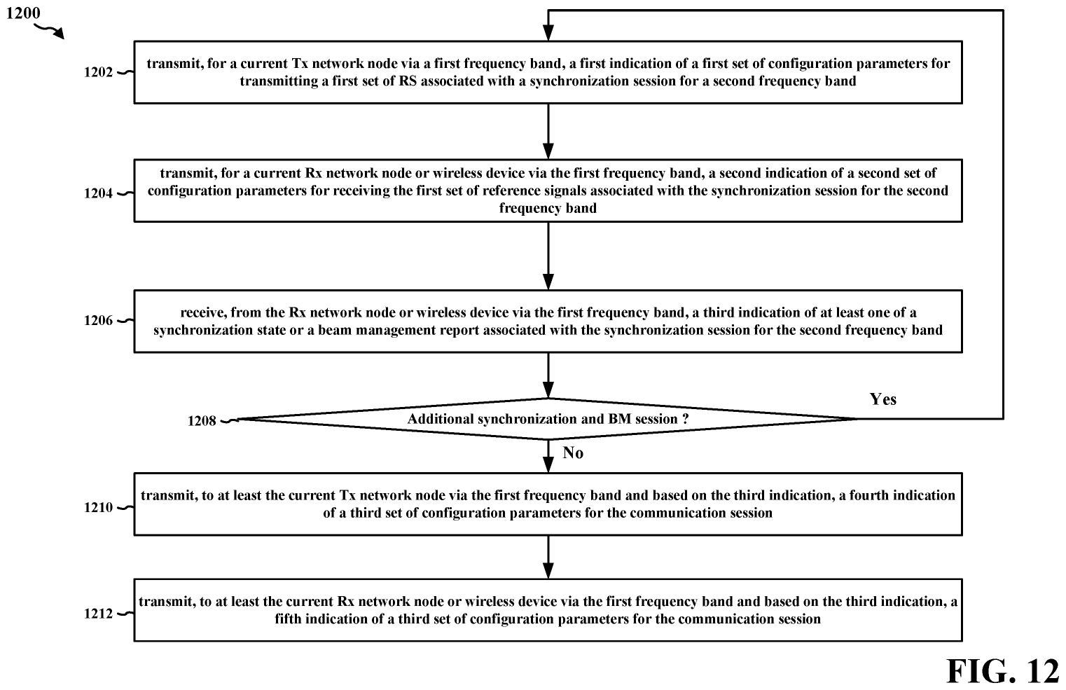

FIG. 12 is a flowchart 1200 of a method of wireless communication. The method may be performed by a base station (e.g., the base station 102, 402 550, 610, 705, or 802; the network entity 1302, 1402, or 1560). At 1202, the base station may transmit, for a second (current) Tx network node via a first frequency band, a first indication of a first set of configuration parameters for transmitting a first set of reference signals associated with a synchronization session for a second frequency band. For example, 1202 may be performed by CU processor 1412, DU processor 1432, RU processor 1442, transceiver(s) 1446, antenna(s) 1480, network interface 1580, network processor 1512, or subTHz sync component 199 of FIG. 14 or 15. In some aspects, the transmission of the first indication may be based on a request for a communication session via the second (e.g., subTHz) frequency band. The set of configuration parameters, in some aspects, may include one or more of a third indication of a sequence associated with reference signals in a set of reference signals associated with the synchronization session, a fourth indication of frequency associated with the reference signals in the set of reference signals, a fifth indication of a set of transmission resources associated with the reference signals in the set of reference signals, or a sixth indication of a set of reception resources associated with the reference signals in the set of reference signals. In some aspects, the set of transmission resources and the set of reception resources may include a set of beams, and the set of transmission resources may be based on at least one transmission resource associated with the first frequency band (e.g., a Tx beam of a PCell link associated with the first frequency band), and the set of reception resources are based on at least one reception resource associated with the first frequency band (e.g., an Rx beam of the PCell link). At least one of the set of transmission resources or the set of reception resources, in some aspects, may be indicated via one of a set of indexes, identifiers, or a set of angular values indicating one of a corresponding directionality or orientation. In some aspects, the set of reference signals includes a modified SSB configured for the synchronization session with the wireless device based on the set of configuration parameters, where the modified SSB carries less information than an unmodified SSB on the first frequency band. For example, referring to FIGS. 5-8 the base station 550, 610, 705, or 802, may transmit sync session scheduling 553, sync session scheduling 755, or synchronization and BM configurations 820 or 830.

In some aspects, the first indication may indicate a time associated with a first reference signal in the set of reference signals. The time associated with the first reference signal, in some aspects, may be indicated based on a first value associated with a first unit of time associated with communication via the first frequency band and a second value associated with a second unit of time associated with communication via the second frequency band. In some aspects, the first unit of time may be larger than the second unit of time. In some aspects, the first indication further indicates an estimated maximum for an absolute value of the timing offset that is added before a beginning and after an end of a first monitoring time, where the first monitoring time begins at a time based on the first time at which the first reference signal is transmitted from the second network node and spans a time configured for a transmission of a plurality of reference signals in the set of reference signals.

At 1204, the base station may transmit, for a current Rx network node or wireless device via the first frequency band, a second indication of a second set of configuration parameters for receiving the first set of reference signals associated with the synchronization session for the second frequency band. For example, 1204 may be performed by CU processor 1412, DU processor 1432, RU processor 1442, transceiver(s) 1446, antenna(s) 1480, network interface 1580, network processor 1512, or subTHz sync component 199 of FIG. 14 or 15. The second indication may include a similar set of parameters as the first indication to coordinate the second (current) Tx network node and the (current) Rx network node or wireless device. For example, referring to FIGS. 5-8 the base station 550, 610, 705, or 802, may transmit sync session scheduling 555, sync session scheduling 655, sync session scheduling 755 or synchronization and BM configurations 822 or 832.

At 1206, the base station may receive, from the current Rx network node or wireless device via the first frequency band, a third indication of at least one of a synchronization state or a beam management report associated with the synchronization session for the second frequency band. For example, 1206 may be performed by CU processor 1412, DU processor 1432, RU processor 1442, transceiver(s) 1446, antenna(s) 1480, network interface 1580, network processor 1512, or subTHz sync component 199 of FIG. 14 or 15. The synchronization state may indicate whether the wireless device was successful in determining a local offset time (e.g., local subTHz ΔTO 515) based on the RS received from the second network node. The beam management report, in some aspects, may include an indication that that a value for a measured signal-strength-characteristic (e.g., an RSRP and/or RSSI) of the set of reference signals is above a threshold value. In some aspects, the beam management report may include at least one identifier associated with at least one reference signal in the set of reference signals, where each reference signal is associated with a transmission beam (or a Tx-Rx beam pair). The beam management report, in some aspects, may include at least one of (1) an indication that the at least one reference signal is associated with a first value for a measured signal-strength-characteristic that is above a threshold value or (2) an indication of a second value for the measured signal-strength-characteristic. In some aspects, the at least one reference signal includes at least a reference signal associated with a highest value of the measured signal-strength-characteristic. For example, referring to FIGS. 5-8, the second device 511, UE 630, Rx hop 730, or UE 806 may transmit, and the base station 550, 610, 705, or 802, may receive synchronization (and BM) report 557, BM report 657 or 757, or synchronization and BM report 838.

At 1208, the base station may determine whether to configure an additional synchronization and BM session. For example, 1208 may be performed by CU processor 1412, DU processor 1432, RU processor 1442, network processor 1512, or subTHz sync component 199 of FIG. 14 or 15. The determination at 1208, in some aspects, may be based on a receiving a confirmation that a synchronization and BM session has been successful and that there is an additional hop in a multi-hop subTHz link to synchronize, that a synchronization has failed, that a threshold time has passed and/or elapsed during an active period of the subTHz link, or that a degradation and/or failure event has occurred. If the base station determines to configure an additional synchronization and BM session (e.g., that a condition for configuring a new synchronization and BM session has been met), the base station may return to 1202 to configure the current Tx node and Rx node for a synchronization and BM session, where the current Tx and Rx node may be the same as for the previous synchronization and BM session in the case of synchronization failure, or a next set of nodes associated with a next hop in a multi-hop subTHz link.

If the base station determines at 1208 to not configure an additional synchronization and BM session, it may proceed to transmit, at 1210, to the second network node via the first frequency band and based on the third indication, a fourth indication of a third set of configuration parameters for the communication session. For example, 1210 may be performed by CU processor 1412, DU processor 1432, RU processor 1442, transceiver(s) 1446, antenna(s) 1480, network interface 1580, network processor 1512, or subTHz sync component 199 of FIG. 14 or 15. The set of configuration parameters for the communication session, in some aspects, may include time-and-frequency resources (e.g., RBs or other resource allocation units) and/or Tx-Rx beam pairs. In some aspects, the set of configuration parameters for the communication session may include an indication indicating at least one identifier included in the beam management report, where the second network node is configured to use, for a data transmission associated with the communication session with the wireless device, at least one transmission beam associated with the at least one identifier included in the beam management report. For example, referring to FIG. 8, the AP/RP 804 may receive, and base station 802 may transmit, communication configuration 842.

At 1212 the base station may transmit, to the wireless device via the first frequency band and based on the third indication, a fifth indication of the third set of configuration parameters for the communication session. For example, 1212 may be performed by CU processor 1412, DU processor 1432, RU processor 1442, transceiver(s) 1446, antenna(s) 1480, network interface 1580, network processor 1512, or subTHz sync component 199 of FIG. 14 or 15. The set of configuration parameters for the communication session, in some aspects, may include time-and-frequency resources (e.g., RBs or other resource allocation units) and/or Tx-Rx beam pairs. In some aspects, the set of configuration parameters for the communication session may include an indication indicating at least one identifier included in the beam management report, where the wireless device is configured to use, for a data transmission associated with the communication session with the second network node, at least one transmission beam associated with the at least one identifier included in the beam management report. For example, referring to FIG. 8, the UE 806 may receive, and base station 802 may transmit, communication configuration 844.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see UE 350 of FIG. 3) and include the additional modules of the apparatus 1304.

As discussed supra, the subTHz sync component 198 may be configured to receive, from a first network node via a first frequency band, a first indication of a set of configuration parameters for a synchronization session for a second frequency band; receive, from a second network node via the second frequency band and based on the first indication, a set of reference signals associated with the synchronization session; and transmit, to the first network node via the first frequency band, a second indication of at least one of a synchronization state or a beam management report associated with the synchronization session for the second frequency band. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for receiving, from a first network node via a first frequency band, a first indication of a set of configuration parameters for a synchronization session for a second frequency band. The apparatus 1304, and in particular the cellular baseband processor 1324 and/or the application processor 1306, may include means for receiving, from a second network node via the second frequency band and based on the first indication, a set of reference signals associated with the synchronization session. The apparatus 1304, and in particular the cellular baseband processor 1324 and/or the application processor 1306, may include means for transmitting, to the first network node via the first frequency band, a second indication of at least one of a synchronization state or a beam management report associated with the synchronization session for the second frequency band. The apparatus 1304, and in particular the cellular baseband processor 1324 and/or the application processor 1306, may include means for receiving or transmitting, before receiving the first indication, a request for a communication session via the second frequency band, wherein the synchronization session synchronizes the wireless device with at least the second network node for the communication session. The apparatus 1304, and in particular the cellular baseband processor 1324 and/or the application processor 1306, may include means for receiving, from the first network node via the first frequency band, a third indication of a second set of configuration parameters for a second synchronization session for the second frequency band. The apparatus 1304, and in particular the cellular baseband processor 1324 and/or the application processor 1306, may include means for receiving, from the second network node via the second frequency band, a second set of reference signals associated with the second synchronization session. The apparatus 1304, and in particular the cellular baseband processor 1324 and/or the application processor 1306, may include means for transmitting, to the first network node via the first frequency band, a fourth indication of at least one of a second synchronization state or a second beam management report associated with the second synchronization session for the second frequency band. The apparatus 1304, and in particular the cellular baseband processor 1324 and/or the application processor 1306, may include means for determining a timing offset between a first time at which the first reference signal is transmitted from the second network node and a second time at which the first reference signal is received at the wireless device based on the first value and the second value. The apparatus 1304, and in particular the cellular baseband processor 1324 and/or the application processor 1306, may include means for receiving, from the first network node via the first frequency band, a sixth indication indicating at least one identifier included in the beam management report. The apparatus 1304, and in particular the cellular baseband processor 1324 and/or the application processor 1306, may include means for communicating, as part of the communication session, with the second network node via the second frequency band using at least one reception beam based on the at least one identifier indicated in the sixth indication associated with the at least one transmission beam which the second network node is configured to use for the data transmission associated with the communication session. The apparatus 1304, and in particular the cellular baseband processor 1324 and/or the application processor 1306, may include means for receiving, from the first network node via the first frequency band and based on the second indication, an additional set of configuration parameters for a communication session associated with the synchronization session. The apparatus 1304, and in particular the cellular baseband processor 1324 and/or the application processor 1306, may include means for communicating with the second network node based on the additional set of configuration parameters for the communication session. The means may be the subTHz sync component 198 of the apparatus 1304 configured to perform the functions recited by the means or any of the operations discussed in relation to FIGS. 9 and 10. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the subTHz sync component 199 may be configured to transmit, for a second network node via a first frequency band, a first indication of a first set of configuration parameters for transmitting a first set of reference signals associated with a synchronization session for a second frequency band; transmit, for a wireless device via the first frequency band, a second indication of a second set of configuration parameters for receiving the first set of reference signals associated with the synchronization session for the second frequency band; and receive, from the wireless device via the first frequency band, a third indication of at least one of a synchronization state or a beam management report associated with the synchronization session for the second frequency band. The subTHz sync component 199 may be within one or more processors of one or more of the CU 1410, DU 1430, and the RU 1440. The subTHz sync component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 may include means for transmitting, for a second network node via a first frequency band, a first indication of a first set of configuration parameters for transmitting a first set of reference signals associated with a synchronization session for a second frequency band. The network entity 1402, in some aspects, may include means for transmitting, for a wireless device via the first frequency band, a second indication of a second set of configuration parameters for receiving the first set of reference signals associated with the synchronization session for the second frequency band. The network entity 1402, in some aspects, may include means for receiving, from the wireless device via the first frequency band, a third indication of at least one of a synchronization state or a beam management report associated with the synchronization session for the second frequency band. The network entity 1402, in some aspects, may include means for transmitting, to the second network node via the first frequency band and based on the third indication, a fourth indication of a third set of configuration parameters for the communication session. The network entity 1402, in some aspects, may include means for transmitting, to the wireless device via the first frequency band and based on the third indication, a fifth indication of the third set of configuration parameters for the communication session. The network entity 1402, in some aspects, may include means for transmitting, for a third network node via the first frequency band, a fourth indication of a third set of configuration parameters for transmitting a second set of reference signals associated with a second synchronization session for the second frequency band. The network entity 1402, in some aspects, may include means for transmitting, for the second network node via the first frequency band, a fifth indication of a fourth set of configuration parameters for receiving the second set of reference signals associated with the second synchronization session for the second frequency band. The network entity 1402, in some aspects, may include means for receiving, from the second network node via the first frequency band, a sixth indication of at least one of a second synchronization state or a second beam management report associated with the second synchronization session for the second frequency band. The means may be the subTHz sync component 199 of the network entity 1402 configured to perform the functions recited by the means or the operations discussed in relation to FIGS. 11 and 12. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the subTHz sync component 199 may be configured to transmit, for a second network node via a first frequency band, a first indication of a first set of configuration parameters for transmitting a first set of reference signals associated with a synchronization session for a second frequency band; transmit, for a wireless device via the first frequency band, a second indication of a second set of configuration parameters for receiving the first set of reference signals associated with the synchronization session for the second frequency band; and receive, from the wireless device via the first frequency band, a third indication of at least one of a synchronization state or a beam management report associated with the synchronization session for the second frequency band. The subTHz sync component 199 may be within the processor 1512. The subTHz sync component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. The network entity 1560, in some aspects, may include means for transmitting, for a wireless device via the first frequency band, a second indication of a second set of configuration parameters for receiving the first set of reference signals associated with the synchronization session for the second frequency band. The network entity 1560, in some aspects, may include means for receiving, from the wireless device via the first frequency band, a third indication of at least one of a synchronization state or a beam management report associated with the synchronization session for the second frequency band. The network entity 1560, in some aspects, may include means for transmitting, to the second network node via the first frequency band and based on the third indication, a fourth indication of a third set of configuration parameters for the communication session. The network entity 1560, in some aspects, may include means for transmitting, to the wireless device via the first frequency band and based on the third indication, a fifth indication of the third set of configuration parameters for the communication session. The network entity 1560, in some aspects, may include means for transmitting, for a third network node via the first frequency band, a fourth indication of a third set of configuration parameters for transmitting a second set of reference signals associated with a second synchronization session for the second frequency band. The network entity 1560, in some aspects, may include means for transmitting, for the second network node via the first frequency band, a fifth indication of a fourth set of configuration parameters for receiving the second set of reference signals associated with the second synchronization session for the second frequency band. The network entity 1560, in some aspects, may include means for receiving, from the second network node via the first frequency band, a sixth indication of at least one of a second synchronization state or a second beam management report associated with the second synchronization session for the second frequency band. The means may be the subTHz sync component 199 of the network entity 1560 configured to perform the functions recited by the means or the operations discussed in relation to FIGS. 11 and 12. The means may be the subTHz sync component 199 of the network entity 1560 configured to perform the functions recited by the means.

In some aspects, the method and apparatus described in the disclosure may provide a low complexity, low power, low latency synchronization and BM procedure for a subTHz link associated with a primary (“always on”) link (e.g., a PCell link) associated with a lower frequency band. The synchronization and BM procedure in accordance with the disclosure may be associated with a reduced list of swept Tx beams addressed in an SSB mini burst and/or synchronization and BM RS block given a known coarse Tx beam per subTHz hop as was described. For example, for static LOS links between infrastructure nodes (e.g., gNB, RP, or AP) a few best candidate beams known from an extensive beam search done as a part of power boot up and/or installation procedure (e.g., performed once with stored results used going forward) may be tested to reconfirm the best Tx beam per subTHz link activation on the related hops.

For direct links with a subTHz UE (gNB-UE or AP-UE), subTHz coarse beam determination may be less accurate (or persistent) and a longer, but still reduced list of subTHz candidate Tx beams may be tested. Overall the suggested approach allows initial acquisition (e.g., synchronization and BM/BR) using a reduced Tx beam search scope. A reduced list of Rx beams, in some aspects, may be tested per Tx beam (across SSB mini burst/synchronization and BM RS block repetitions). The considerations allowing the reduced Tx beam search space, in some aspects, apply to Rx beams as well allowing a reduction of an Rx beam search space.

In inter-band carrier aggregation, the low complexity, low latency, low power synchronization and BM procedure may not use “always on” signals and RACH for synchronization and beam management for all CCs. A sync RS/SSB mini burst repetitions may be used to achieve low latency RX beam hypothesis testing instead of waiting for a next SSB burst occurrence to test RX beam hypothesis. This on-demand sync RS/SSB mini burst may be possible because of the low expected number of served UEs which allow dedicated scheduling of the sync sessions. Additionally, a modified “In Sync report” in response to a synchronization and BM session is provided in some aspects allowing adaptions to achieve faster synchronization.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving, from a first network node via a first frequency band, a first indication of a set of configuration parameters for a synchronization session for a second frequency band; receiving, from a second network node via the second frequency band and based on the first indication, a set of reference signals associated with the synchronization session; and transmitting, to the first network node via the first frequency band, a second indication of at least one of a synchronization state or a beam management report associated with the synchronization session for the second frequency band.

Aspect 2 is the method of aspect 1, where the set of configuration parameters comprise one or more of a third indication of a sequence associated with reference signals in the set of reference signals associated with the synchronization session, a fourth indication of frequency associated with the reference signals in the set of reference signals, a fifth indication of a set of transmission resources associated with the reference signals in the set of reference signals, or a sixth indication of a set of reception resources associated with the reference signals in the set of reference signals.

Aspect 3 is the method of aspect 2, where the set of transmission resources and the set of reception resources comprise a set of beams, the set of transmission resources are based on at least one transmission resource associated with the first frequency band, and the set of reception resources are based on at least one reception resource associated with the first frequency band.

Aspect 4 is the method of aspect 3, where at least one of the set of transmission resources or the set of reception resources are indicated via one of a set of indexes, identifiers, or a set of angular values indicating one of a corresponding directionality or orientation.

Aspect 5 is the method of any of aspects 1 to 4, where the set of reference signals comprises a modified SSB configured for the synchronization session with the wireless device based on the set of configuration parameters, the modified SSB carrying less information than an unmodified SSB on the first frequency band.

Aspect 6 is the method of any of aspects 1 to 5, further including receiving or transmitting, before receiving the first indication, a request for a communication session via the second frequency band, where the synchronization session synchronizes the wireless device with at least the second network node for the communication session.

Aspect 7 is the method of any of aspects 1 to 6, where the synchronization session is a first synchronization session associated with a communication session, the method further including: receiving, from the first network node via the first frequency band, a third indication of a second set of configuration parameters for a second synchronization session for the second frequency band, where the third indication is received based on at least one of a threshold time elapsing during the communication session, the second indication indicating a failed synchronization state, or a measure of communication quality falling below a threshold value; receiving, from the second network node via the second frequency band, a second set of reference signals associated with the second synchronization session; and transmitting, to the first network node via the first frequency band, a fourth indication of at least one of a second synchronization state or a second beam management report associated with the second synchronization session for the second frequency band.

Aspect 8 is the method of any of aspects 1 to 7, where the first indication indicates a time associated with a first reference signal in the set of reference signals, where the time associated with the first reference signal is indicated based on a first value associated with a first unit of time associated with communication via the first frequency band and a second value associated with a second unit of time associated with communication via the second frequency band, where the first unit of time is larger than the second unit of time, and the method further includes: determining a timing offset between a first time at which the first reference signal is transmitted from the second network node and a second time at which the first reference signal is received at the wireless device based on the first value and the second value, where the timing offset is used to synchronize the wireless device and the second network node during a subsequent communication session corresponding to the synchronization session.

Aspect 9 is the method of aspect 8, where the first indication further indicates an estimated maximum for an absolute value of the timing offset that is added before a beginning and after an end of a first monitoring time, where the first monitoring time begins at a time based on the first time at which the first reference signal is transmitted from the second network node and spans a time configured for a transmission of a plurality of reference signals in the set of reference signals.

Aspect 10 is the method of any of aspects 8 and 9, where the plurality of reference signals in the set of reference signals is a first subset of reference signals associated with a corresponding set of at least one of spatial-domain resources or beams for reference signal transmission, where the plurality of reference signals is associated with at least one of a first spatial-domain resource or beam for reception of the plurality of reference signals and the plurality of reference signals is repeated for each of a plurality of spatial-domain resources or beams with a period that is equal to the first monitoring time plus twice the absolute value of the timing offset and a reception beam switching time.

Aspect 11 is the method of any of aspects 1 to 10, where the second indication comprises the synchronization state and the synchronization state comprises a third indication that a value for a measured signal-strength-characteristic of the set of reference signals is above a threshold value.

Aspect 12 is the method of any of aspects 1 to 11, where the second indication comprises the beam management report associated with the synchronization session and the beam management report comprises at least one identifier associated with at least one reference signal in the set of reference signals, where each reference signal is associated with a transmission beam.

Aspect 13 is the method of aspect 12, where the beam management report further comprises at least one of a third indication that the at least one reference signal is associated with a first value for a measured signal-strength-characteristic that is above a threshold value or a fourth indication of a second value for the measured signal-strength-characteristic.

Aspect 14 is the method of aspect 13, where the at least one reference signal comprises at least a reference signal associated with a highest value of the measured signal-strength-characteristic.

Aspect 15 is the method of aspect 14, where the synchronization session is associated with a communication session, the method further comprising: receiving, from the first network node via the first frequency band, a sixth indication indicating at least one identifier included in the beam management report, where the second network node is configured to use, for a data transmission associated with the communication session with the wireless device, at least one transmission beam associated with the at least one identifier included in the beam management report; and communicating, as part of the communication session, with the second network node via the second frequency band using at least one reception beam based on the at least one identifier indicated in the sixth indication associated with the at least one transmission beam which the second network node is configured to use for the data transmission associated with the communication session.

Aspect 16 is the method of any of aspects 1 to 15, the method further including receiving, from the first network node via the first frequency band and based on the second indication, an additional set of configuration parameters for a communication session associated with the synchronization session; and communicating with the second network node based on the additional set of configuration parameters for the communication session.

Aspect 17 is a method of wireless communication at a first network node, including: transmitting, for a second network node via a first frequency band, a first indication of a first set of configuration parameters for transmitting a first set of reference signals associated with a synchronization session for a second frequency band; transmitting, for a wireless device via the first frequency band, a second indication of a second set of configuration parameters for receiving the first set of reference signals associated with the synchronization session for the second frequency band; and receiving, from the wireless device via the first frequency band, a third indication of at least one of a synchronization state or a beam management report associated with the synchronization session for the second frequency band.

Aspect 18 is the method of aspect 17, where the synchronization session is associated with a communication session, the method further comprising: transmitting, to the second network node via the first frequency band and based on the third indication, a fourth indication of a third set of configuration parameters for the communication session; and transmitting, to the wireless device via the first frequency band and based on the third indication, a fifth indication of the third set of configuration parameters for the communication session.

Aspect 19 is the method of any of aspects 17 and 18, where the synchronization session is a first synchronization session, the method further including: transmitting, for a third network node via the first frequency band, a fourth indication of a third set of configuration parameters for transmitting a second set of reference signals associated with a second synchronization session for the second frequency band; transmitting, for the second network node via the first frequency band, a fifth indication of a fourth set of configuration parameters for receiving the second set of reference signals associated with the second synchronization session for the second frequency band; and receiving, from the second network node via the first frequency band, a sixth indication of at least one of a second synchronization state or a second beam management report associated with the second synchronization session for the second frequency band, where the second synchronization session precedes the first synchronization session and the first synchronization session is based on the second synchronization session.

Aspect 20 is the method of aspect 19, where the first network node comprises a first AP at a first base station serving as a primary cell for the second network node, the third network node, and the wireless device, where the second network node comprises one of a second AP or a first relay AP, where the third network node comprises one of a third AP at the first base station, a fourth AP, or a second relay AP, and where the wireless device comprises a user equipment.

Aspect 21 is the method of any of aspects 19 and 20, where the first set of configuration parameters for transmitting the first set of reference signals are different than the third set of configuration parameters for transmitting the second set of reference signals and the second set of configuration parameters for receiving the first set of reference signals are different than the fourth set of configuration parameters for receiving the second set of reference signals.

Aspect 22 is an apparatus for wireless communication at a device including a memory and at least one processor coupled to the memory and, based at least in part on information stored in the memory, the at least one processor is configured to implement any of aspects 1 to 21.

Aspect 23 is the method of aspect 22, further including a transceiver or an antenna coupled to the at least one processor.

Aspect 24 is an apparatus for wireless communication at a device including means for implementing any of aspects 1 to 21.

Aspect 25 is a computer-readable medium (e.g., a non-transitory computer-readable medium) storing computer executable code, where the code when executed by a processor causes the processor to implement any of aspects 1 to 21.

What is claimed is:

1. An apparatus for wireless communication at a wireless device, comprising:
a memory; and
at least one processor coupled to the memory and, based at least in part on information stored in the memory, the at least one processor is configured to:
receive, from a first network node via a first frequency band, a first indication of a set of configuration parameters for a synchronization session for a second frequency band;
receive, from a second network node via the second frequency band and based on the first indication, a set of reference signals associated with the synchronization session; and
transmit, to the first network node via the first frequency band, a second indication of at least one of a synchronization state or a beam management report associated with the synchronization session for the second frequency band.

2. The apparatus of claim 1, wherein the set of configuration parameters comprise one or more of a third indication of a sequence associated with reference signals in the set of reference signals associated with the synchronization session, a fourth indication of frequency associated with the reference signals in the set of reference signals, a fifth indication of a set of transmission resources associated with the reference signals in the set of reference signals, or a sixth indication of a set of reception resources associated with the reference signals in the set of reference signals.

3. The apparatus of claim 2, wherein the set of transmission resources and the set of reception resources comprise a set of beams, the set of transmission resources are based on at least one transmission resource associated with the first frequency band, and the set of reception resources are based on at least one reception resource associated with the first frequency band.

4. The apparatus of claim 3, wherein at least one of the set of transmission resources or the set of reception resources are indicated via one of a set of indexes, identifiers, or a set of angular values indicating one of a corresponding directionality or orientation.

5. The apparatus of claim 2, wherein the set of reference signals comprises a modified synchronization signal block (SSB) configured for the synchronization session with the wireless device based on the set of configuration parameters, the modified SSB carrying less information than an unmodified SSB on the first frequency band.

6. The apparatus of claim 1, where in the at least one processor is further configured to:
receive or transmit, before receiving the first indication, a request for a communication session via the second frequency band, wherein the synchronization session synchronizes the wireless device with at least the second network node for the communication session.

7. The apparatus of claim 1, wherein the synchronization session is a first synchronization session associated with a communication session, and the at least one processor is further configured to:
receive, from the first network node via the first frequency band, a third indication of a second set of configuration parameters for a second synchronization session for the second frequency band, wherein the at least one processor is configured to receive the third indication based on at least one of a threshold time elapsing during the communication session, the second indication indicating a failed synchronization state, or a measure of communication quality falling below a threshold value;
receive, from the second network node via the second frequency band, a second set of reference signals associated with the second synchronization session; and
transmit, to the first network node via the first frequency band, a fourth indication of at least one of a second synchronization state or a second beam management report associated with the second synchronization session for the second frequency band.

8. The apparatus of claim 1, wherein the first indication indicates a time associated with a first reference signal in the set of reference signals, wherein the time associated with the first reference signal is indicated based on a first value associated with a first unit of time associated with communication via the first frequency band and a second value associated with a second unit of time associated with communication via the second frequency band, wherein the first unit of time is larger than the second unit of time, and wherein the at least one processor is further configured to:
determine a timing offset between a first time at which the first reference signal is transmitted from the second network node and a second time at which the first reference signal is received at the wireless device based on the first value and the second value, wherein the timing offset is used to synchronize the wireless device and the second network node during a subsequent communication session corresponding to the synchronization session.

9. The apparatus of claim 8, wherein the first indication further indicates an estimated maximum for an absolute value of the timing offset that is added before a beginning and after an end of a first monitoring time, wherein the first monitoring time begins at a time based on the first time at which the first reference signal is transmitted from the second network node and spans a time configured for a transmission of a plurality of reference signals in the set of reference signals.

10. The apparatus of claim 9, wherein the plurality of reference signals in the set of reference signals is a first subset of reference signals associated with a corresponding set of at least one of spatial-domain resources or beams for reference signal transmission, wherein the plurality of reference signals is associated with at least one of a first spatial-domain resource or beam for reception of the plurality of reference signals and the plurality of reference signals is repeated for each of a plurality of spatial-domain resources or beams with a period that is equal to the first monitoring time plus twice the absolute value of the timing offset and a reception beam switching time.

11. The apparatus of claim 1, wherein the second indication comprises the synchronization state and the synchronization state comprises a third indication that a value for a measured signal-strength-characteristic of the set of reference signals is above a threshold value.

12. The apparatus of claim 1, wherein the second indication comprises the beam management report associated with the synchronization session and the beam management report comprises at least one identifier associated with at least one reference signal in the set of reference signals, wherein each reference signal is associated with a transmission beam.

13. The apparatus of claim 12, wherein the beam management report further comprises at least one of a third indication that the at least one reference signal is associated with a first value for a measured signal-strength-characteristic that is above a threshold value or a fourth indication of a second value for the measured signal-strength-characteristic.

14. The apparatus of claim 13, wherein the at least one reference signal comprises at least a reference signal associated with a highest value of the measured signal-strength-characteristic.

15. The apparatus of claim 14, wherein the synchronization session is associated with a communication session, and the at least one processor is further configured to:
receive, from the first network node via the first frequency band, a sixth indication indicating at least one identifier included in the beam management report, wherein the second network node is configured to use, for a data transmission associated with the communication session with the wireless device, at least one transmission beam associated with the at least one identifier included in the beam management report; and
communicate, as part of the communication session, with the second network node via the second frequency band using at least one reception beam based on the at least one identifier indicated in the sixth indication associated with the at least one transmission beam which the second network node is configured to use for the data transmission associated with the communication session.

16. The apparatus of claim 1, wherein the at least one processor is further configured to:
receive, from the first network node via the first frequency band and based on the second indication, an additional set of configuration parameters for a communication session associated with the synchronization session; and
communicate with the second network node based on the additional set of configuration parameters for the communication session.

17. An apparatus for wireless communication at a first network node, comprising:
a memory; and
at least one processor coupled to the memory and, based at least in part on information stored in the memory, the at least one processor is configured to:
transmit, for a second network node via a first frequency band, a first indication of a first set of configuration parameters for transmitting a first set of reference signals associated with a synchronization session for a second frequency band;
transmit, for a wireless device via the first frequency band, a second indication of a second set of configuration parameters for receiving the first set of reference signals associated with the synchronization session for the second frequency band; and
receive, from the wireless device via the first frequency band, a third indication of at least one of a synchronization state or a beam management report associated with the synchronization session for the second frequency band.

18. The apparatus of claim 17, wherein the synchronization session is associated with a communication session, and the at least one processor is further configured to:
transmit, to the second network node via the first frequency band and based on the third indication, a fourth indication of a third set of configuration parameters for the communication session; and
transmit, to the wireless device via the first frequency band and based on the third indication, a fifth indication of the third set of configuration parameters for the communication session.

19. The apparatus of claim 17, wherein the apparatus further comprises at least one transceiver coupled to the at least one processor, and the synchronization session is a first synchronization session, and the at least one processor is further configured to:
transmit, for a third network node via the first frequency band, a fourth indication of a third set of configuration parameters for transmitting a second set of reference signals associated with a second synchronization session for the second frequency band;
transmit, for the second network node via the first frequency band, a fifth indication of a fourth set of configuration parameters for receiving the second set of reference signals associated with the second synchronization session for the second frequency band; and
receive, from the second network node via the first frequency band, a sixth indication of at least one of a second synchronization state or a second beam management report associated with the second synchronization session for the second frequency band, wherein the second synchronization session precedes the first synchronization session and the first synchronization session is based on the second synchronization session.

20. The apparatus of claim 19,
wherein the first network node comprises a first access point (AP) at a first base station serving as a primary cell for the second network node, the third network node, and the wireless device,
wherein the second network node comprises one of a second AP or a first relay AP,
wherein the third network node comprises one of a third AP at the first base station, a fourth AP, or a second relay AP, and
wherein the wireless device comprises a user equipment.

21. The apparatus of claim 19, wherein the first set of configuration parameters for transmitting the first set of reference signals are different than the third set of configuration parameters for transmitting the second set of reference signals and the second set of configuration parameters for receiving the first set of reference signals are different than the fourth set of configuration parameters for receiving the second set of reference signals.

22. A method of wireless communication for a wireless device, comprising:
receiving, from a first network node via a first frequency band, a first indication of a set of configuration parameters for a synchronization session for a second frequency band;
receiving, from a second network node via the second frequency band and based on the first indication, a set of reference signals associated with the synchronization session; and
transmitting, to the first network node via the first frequency band, a second indication of at least one of a synchronization state or a beam management report associated with the synchronization session for the second frequency band.

23. The method of claim 22, wherein the set of configuration parameters comprise one or more of a second indication of a sequence associated with reference signals in the set of reference signals associated with the synchronization session, a third indication of frequency associated with the reference signals in the set of reference signals, a fourth indication of a set of transmission resources associated with the reference signals in the set of reference signals, or a fifth indication of a set of reception resources associated with the reference signals in the set of reference signals.

24. The method of claim 23, wherein the set of transmission resources and the set of reception resources comprise a set of beams, the set of transmission resources are based on at least one transmission resource associated with the first frequency band, and the set of reception resources are based on at least one reception resource associated with the first frequency band.

25. The method of claim 23, wherein the set of reference signals comprises a modified synchronization signal block (SSB) configured for the synchronization session with the wireless device based on the set of configuration parameters, the modified SSB carrying less information than an unmodified SSB on the first frequency band.

26. The method of claim 22, wherein the first indication indicates a time associated with a first reference signal in the set of reference signals, wherein the time associated with the first reference signal is indicated based on a first value associated with a first unit of time associated with communication via the first frequency band and a second value associated with a second unit of time associated with communication via the second frequency band, wherein the first unit of time is larger than the second unit of time, and wherein the wireless device is further configured to:
determine a timing offset between a first time at which the first reference signal is transmitted from the second network node and a second time at which the first reference signal is received at the wireless device based on the first value and the second value, wherein the timing offset is used to synchronize the wireless device and the second network node during a subsequent communication session corresponding to the synchronization session.

27. The method of claim 26, wherein the first indication further indicates an estimated maximum for an absolute value of the timing offset that is added before a beginning and after an end of a first monitoring time, wherein the first monitoring time begins at a time based on the first time at which the first reference signal is transmitted from the second network node and spans a time configured for a transmission of a plurality of reference signals in the set of reference signals.

28. The method of claim 27, wherein the plurality of reference signals in the set of reference signals is a first subset of reference signals associated with a corresponding set of at least one of spatial-domain resources or beams for reference signal transmission, wherein the plurality of reference signals is associated with at least one of a first spatial-domain resource or beam for reception of the plurality of reference signals and the plurality of reference signals is repeated for each of a plurality of spatial-domain resources or beams with a period that is equal to the first monitoring time plus twice the absolute value of the timing offset and a reception beam switching time.

29. A method of wireless communication for a first network node, comprising:
transmitting, for a second network node via a first frequency band, a first indication of a first set of configuration parameters for transmitting a first set of reference signals associated with a synchronization session for a second frequency band;
transmitting, for a wireless device via the first frequency band, a second indication of a second set of configuration parameters for receiving the first set of reference signals associated with the synchronization session for the second frequency band; and
receiving, from the wireless device via the first frequency band, a third indication of at least one of a synchronization state or a beam management report associated with the synchronization session for the second frequency band.

30. The method of claim 29, wherein the synchronization session is associated with a communication session, the method further comprising:
transmitting, to the second network node via the first frequency band and based on the third indication, a fourth indication of a third set of configuration parameters for the communication session; and
transmitting, to the wireless device via the first frequency band and based on the third indication, a fifth indication of the third set of configuration parameters for the communication session.
